(19) United States
(12) Patent Application Publication
(10) Pub. No.: US 2005/0171932 A1
(43) Pub. Date: Aug. 4, 2005

(54) Method and system for extracting, analyzing, storing, comparing and reporting on data stored in web and/or other network repositories and apparatus to detect, prevent and obfuscate information removal from information servers

(76) Inventor: Ian R Nandhra, Sonora, CA (US)

Correspondence Address: BEYER WEAVER & THOMAS LLP, P.O. BOX 70250, OAKLAND, CA, 94612-0250, US

(21) Appl. No.: 10/517,738

(22) PCT Filed: Feb. 23, 2001
(86) PCT No.: PCT/US01/05895

(30) Foreign Application Priority Data
Feb. 24, 2000 (US) 60184727
May 18, 2000 (US) 60205619

(51) Int. Cl. G06F 7/00

(52) U.S. Cl. 707/3

(57) ABSTRACT

A system, method and apparatus providing for the search, identification, retrieval and analysis of data contained in World Wide Web (WWW) and network pages and storage repositories. Mechanisms are provided to facilitate selection of such data as is required by a user, to report in a manner required by the user and to present the results in a plurality of ways. Also disclosed is a system, method to protect information retrieval from Information Servers such as those found on the world wide web (WWW). A method is described to analyze accesses to the information server for patterns indicating the type of system accessing the server. A method is described to format information such that it cannot be easily machine analyzed by such apparatus as lexical analysis and textual search methods. A method is described to include information into information server contents such that it would mislead and otherwise confuse non-human systems used to retrieve the data. Other methods describe access signature analysis and how this can be used to detect and optionally prevent or modify information requests.

### TECHNICAL FIELD

The present invention relates to a method of retrieving data from data sources and, in particular, to a method of retrieving data from data sources such as structured data sources, semi-structured data sources and unstructured data sources, many of which may be rapidly changing. The present invention further relates to a method of analyzing access to an information server and, optionally, acting upon the analysis.

### BACKGROUND

The increased popularity of computer networks generally, and the World Wide Web (WWW) in particular, has increased both the amount and complexity of data available. This poses great difficulty to those wishing to find something of specific interest in a data repository. The now widespread existing world wide web search engines and extraction tools suffer from a number of drawbacks. For example, many search engines base the ranking of results on payment by the data provider, as opposed to being based on the relevance of the result data to the search query. For example, one trying to decide where to purchase a dozen roses using current search engines and extraction tools may be presented with a wide variety of potentially misleading information, including possibly one or two suppliers who have paid for their placement in the display of search results.

Search engines and browsers only help users locate and inspect information That the search engine has cataloged, while tracking tools can help users keep up-to-date on changes to pertinent information. The ability of a search engine to index information is compromised somewhat by the rapidly changing nature of the data being indexed. For example, a user of a search engine is many times directed by the search engine to pages that are misleading, irrelevant or even no longer in use. Moreover, it is almost impossible to identify and automatically compare the results obtained from the search without resorting to visual techniques (i.e., looking at the pages).

There are conventional tools are available to facilitate the comparison of pages in a web repository, detect changes in a web page and facilitate a search for specific text. These tools have various limitations, though. In the “rose” example above, the rose seeker would benefit from a mechanism to identify all the sources of roses and similar fauna in a geographical area and display the prices. A change in price represents a change in the content of the page that could be detected by conventional tools. However, tools that detect changes over time are confused by the common practice of including the date or time in a web page, leading the tool to believe that the page had changed. Furthermore, pages created by Active Server Page (ASP) servers typically add data or information to a page that is not normally visible using a web browser. This non-visible information confuses conventional tools that search for information in a WWW page.

There are a number of conventional products that copy portions or the entire contents of WWW sites. Examples of these products—commonly termed “web mirrors”—include Teleport Pro, SiteEater and NetAttache. There are also many web-based services that provide specific information on topics of interest and compare data. Examples of these are the now ubiquitous search engines such as Lycos and Yahoo, and price “watching” sites such as www.pricewatch.com and aggregation products such as those from NQL Inc. For example, web mirror products download portions or the entire contents of web sites and optionally perform some analysis of the data being extracted. Some allow the user to search for text in the pages and others detect differences between previous downloaded versions. Problems and limitations include:
They can quickly get “lost” in the web. For example, if one is looking for a file called myFile.zip in the archive site www.bhs.com (a large and well known repository for the Windows-NT operating system), a web mirror does not have the intelligence to determine that the zip file is located on an external “hidden” server (no domain name, just an IP address), the link to which can be found only through several levels of indirection. In its attempt to retrieve the myFile.zip file, a web mirror product would typically attempt to download the entire www.bhs.com site, attached advertisement servers, sundry off-site references and ultimately the contents of the entire web. The practice of putting the target file onto a hidden server is common in web repositories and is intended to keep ASP server design simple and confuse robots gathering the data. As just discussed, this can be a very effective technique.
The text search can become confused by the now rampant practice of including comments, control statements, Javascript and other material into web pages.
The widespread practice of including date and time information into a page means that the page tomorrow is different from the page today, rendering the concept of detecting changes over time virtually useless. Some current tools attempt to eliminate this disadvantage by looking for and ignoring date fields, others by letting the user exclude the field. However, even ignoring time and date fields does not address the problems caused by very widespread practice of changing advertisements on a web page.
Web mirror tools that compare web pages lack the sophistication to convert the data into a contextually similar format such that it can be compared. For example, considering the comparison of the following text contained on two web sites: “Books for sale, from $5.00” and “Romantic Novel Sale! Prices starting at $5.00”, the English meaning of these two phrases is the same, yet the text is different and would fail a text comparison and render any form of automatic analysis extremely difficult. Another example, considering the comparison of the following text contained in two documents: “Burger, fries and large soda, $4.95” and “Burgers, soda and fries for $5.00” contains a small difference the meaning of which is entirely dependent on the reader. Such variations in textual construction and similar meaning are commonplace in documents such as those found on the web and are to be expected.
Furthermore, services on the world wide web that provide comparisons and analysis are becoming increasingly popular, yet all of these are server side. That is, they are systems that provide the service or data to other systems connected to them. For example, a user would use a web browser to access data on a server which provided price comparison information. The user would be a client to the server providing the requested data. Server side service providers typically employ a variety of techniques to compare and provide data. These techniques typically include:
   Arranging some sort of paying relationship with the site(s) that are providing data for the service.
   Having a series of ad-hoc scripts and programs to gather data.
   Actually having people manually type or enter data into the database.

Furthermore, there products that employ clervers and keyword searches in the fields of data identification, one such product being available from www.opencola.com. Such products attempt to identify the relevancy of data in a data repository by comparing the data with a set of keywords defined by the user. The higher the number of keywords matches found, the more relevant the data is considered to be. Some such systems claim the ability to self-learn additional keywords to be used in future comparisons.

There are many disadvantages of this technique, and particularly to using keywords. A significant disadvantage is the inability to identify the meaning of the keywords and the context in which they are used. For example, the words “lite” and “light” can be used in the context of electrical illumination as in “lite bulb” and “light bulb”. “Lite” is the American English equivalent of the British English word “light” but also has contextual meaning in terms of the mass of the object being referred to. Such dualities of meaning and spelling should be expected, as should be miss-spellings, grammatical errors and plural terms. This document has used the term “miss-spelling”, but could equally have used the term “misspelling” or “miss spelling”. Even using similar keyword combinations can give rise to incorrect matches as in the example textual fragment “. . . contact Miss Spelling who has found your lost dog . . . ” Furthermore, the possibilities of plural terms, hyphenated terms and possessive terms increase the number of keyword permutations leading to an exponential increase in comparison time, storage requirements and potential for error. Keyword comparisons lack the ability to combine meaning and context and cannot easily or accurately cope with the unknown multiplicity of combinations that are to be expected in documents such as those found on the World Wide Web.

Keyword comparison systems not extracting the meaning of the data being examined make contextual analysis difficult, if not impossible, resulting in the inability to validate the accuracy of the data being examined. This lack of meaning and context can require significant human examination of the data and renders collaborative sharing with others more difficult.

Accuracy of a data item can be defined as the measure of difference between the meaning of a data item and that of a reference data item. Determining the accuracy of data from sources of unknown reliability typically involves comparisons against other data considered to be of a similar nature from a reliable sources. For example, a data item expressing the mathematical sum 2+2=5 is obviously false due to the overwhelming amount of evidence to the contrary. Determining a measure of accuracy of information found in large, unstructured repositories such as those on the World Wide Web (e.g., news sites) involves cross-referencing different data from many different sources producing a list of similar data. The larger the amount of corroborating data, the higher the degree of reliability or accuracy. Since the nature of the data is unknown, keyword searches as used in the art do not provide an indication of similarity or dissimilarity and can be considered inaccurate.

On the other hand, a supplier of books on the world wide web (for example) wants potential customers to access their web site, but does not want their competitors to download all the information for analysis.

### SUMMARY

The invention relates to a system to recursively identify, selectively extract, compare, store and report on data from defined web and network data sources. The system provides mechanisms for a user to define data sources, to define extraction and rejection criteria, and to define actions to be taken on the extracted data. In accordance with other aspects of the invention, data stores are provided that dynamically adapt to the nature and meaning of the data that is stored in it in a manner that ascribes the meaning and context of the data with respect to other data.

In specific embodiments, users can input criteria which are then used to locate and extract data in data sources on the world wide web and/or other computer networks. Once accessed, the data is analyzed using criteria defined by the user, optionally stored, and presented to the user in a form defined by the user. The extraction, comparison and analysis may be either “client side”, “server side”, or in a combination called a “clerver” but should not be considered restricted to such devices or device combinations.

The use of user-defined data sets and set locations overcomes the problems associated with ASP (Active Server Pages) pages generated by ASP servers or other systems that generate a web page on request. For example, the user may define what data sets are to be checked for a change, rather than simply checking that the page has changed in an indeterminate manner. In addition, methods are provided to track changes in the location of the data. Once a data item has been located, its contextual meaning, location and immediate environment may be recorded such that the data item can later be found even in the event that its location changes.

In some embodiments, the method operates based on a Universal Data Locator Object (UDIO) that defines a route to the data by effectively prohibiting the extraction engine from following links that do not lead to a particular type of data. This may involve a mixture of directing the engine down a link to search for data and only allowing a specific level of depth and only a particular specified number of sites away from the start location. There may also be constraints on the breadth and depth traversal to constrain the amount of data being examined. There may also be constraints on the time taken for such operations.

As for the comparison operation, in some embodiments, the data is “normalized” before comparison. The normalization in some embodiments may require access to potentially large quantities of data the meaning and context of which are obtained from the storage devices. By normalizing the data, the data to be compared is in a contextually compatible format that can then be used to generate reports, compare with other contextually similar data, and other purposes that the specific embodiment may require. In addition, by employing the context, the amount of data that needs to be considered is diminished.

Consumers and businesses can all benefit from a mechanism that facilitates the easy identification and comparison of data. For example, those performing electronic commerce can easily identify and catalog information on web repositories of their competitors.

In accordance with another aspect, the present invention is a method and apparatus that enable data requests to an information server to be analyzed, logged and/or displayed before a plurality of optional modifications are made to the request and/or data supplied by the information server.

Furthermore, a system is provided to identify the nature and origin of access to a networked data repository, allowing actions to be performed appropriate to the identified nature and origin of the access. The identification of hit origins allow information servers to be protected from undesired usage of information accessed whilst allowing otherwise full information availability.

Yet further, methods and apparatus are provided that present the information contained in an information server in a manner that makes the information difficult or impossible to be easily analyzed by means other than by direct human inspection (e.g., visually). Since the amount of information on information servers and repositories is large, human inspection, analysis and comparison of such data would typically be prohibitively time consuming and such inspection would thus typically be required to be performed by automated methods such as an electronic computer.

In accordance with an aspect of the invention, access records and information maintained on the information server relating to all accesses to the server are analyzed to determine a hit signature for each of the hit origins. The hit signature is analyzed to determine such characteristics that would result in a probability of the hit origins. Information from the hit signatures is then used to control the access to and information provided by an information server.

### BRIEF DESCRIPTION OF THE DRAWINGS

FIG. 1. A diagram showing the various components of a simple electronic computer which embodiments could use to facilitate operation of the invention.

FIG. 2. A diagram showing an overview of a system used to extract data from example data repositories typical of those to be found on the world wide web.

FIG. 3. A diagram showing how a plurality of data locations appear in an example World Wide Web page.

FIG. 4. A diagram showing data identifiers used to describe data blocks.

FIG. 5. A diagram showing the components of a Universal Parameter Object (UPO)

FIG. 6. A diagram showing the components of a Natural Language Processor.

FIG. 7. A diagram showing different types of Natural Language.

FIG. 8. A diagram showing how Word Identifiers contain word meanings and equivalents and associated actions.

FIG. 9. A diagram showing how Word Identifiers map to Natural Language.

FIG. 10. A diagram showing Headword and Synonym relationships.

FIG. 11. A diagram showing example Word Classifications.

FIG. 12. A diagram showing word meaning comparisons.

FIG. 13. A diagram showing word expectation relationships.

FIG. 14. A diagram showing basic store types and triggers.

FIG. 15. A diagram illustrating interconnections of volatile and persistent adaptive storage cells across a network and residing in the same system.

FIG. 16. A diagram showing a storage application programming interface (API) addressing the incompatibilities and inconsistencies between various storage devices.

FIG. 17. A diagram showing an adaptive store including an Index and an Adaptive List referencing data objects.

FIG. 18. A diagram showing illustrating an adaptive store without any indexing mechanism.

FIG. 19. A diagram depicting a simple access to an adaptive store.

FIG. 20. A diagram showing priority values in an adaptive store. FIG. 20-1 illustrates an algorithm for accessing the adaptive FIG. 20 adaptive store.

FIG. 21. A diagram showing a series of URL's in a chain that eventually locate a data item.

FIG. 22. A diagram showing the components of a Universal Data Identifier (UDI) that combines the parameters required to extract the data from a repository.

FIG. 23. A diagram showing the components of a Universal Resource Locator UDI that combines the parameters required to extract the data from the world wide web.

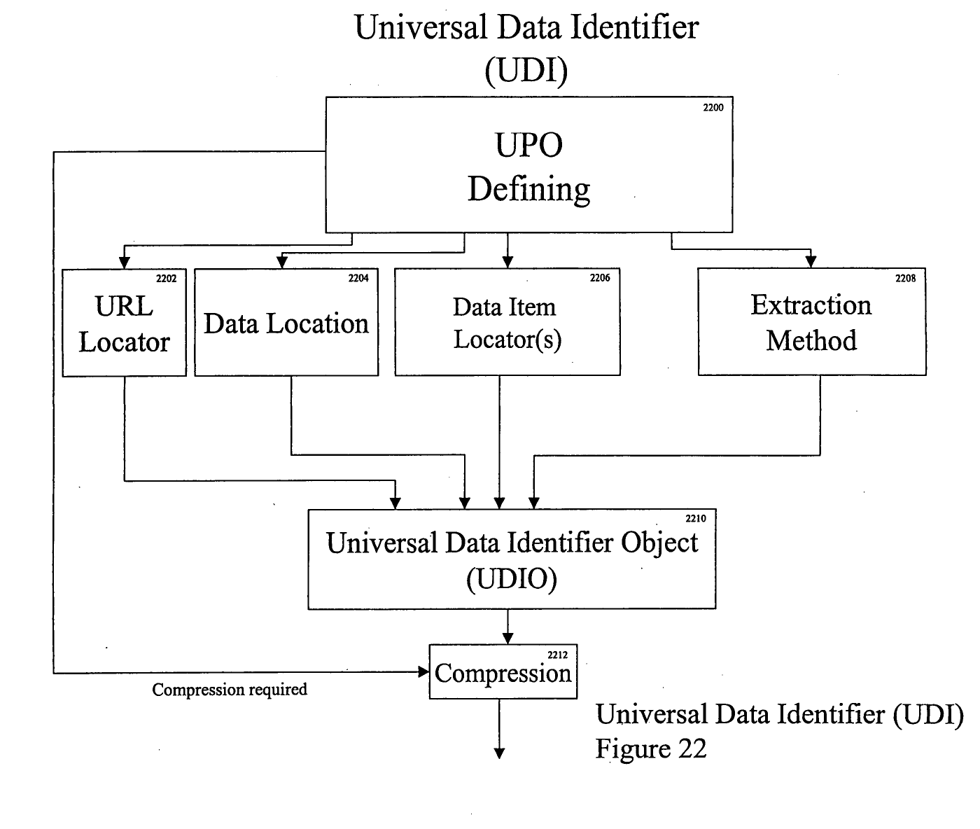

FIG. 24. A diagram showing the components of the Client Data Extractor which uses UDIO objects from the UDI to extract data from data repositories.

FIG. 25. A diagram showing the components of the world wide web extraction engine which uses UDIO objects from the UDI to extract data from world wide web data repositories.

FIG. 26. A diagram showing the components of the URL Download Manager that determines if a URL's data should be downloaded and performs the download process which in preferred embodiments would involve the use of threads. Also shown are hit signature criteria.

FIG. 27. A diagram showing the components of the URL List Manager.

FIG. 28. A diagram showing the components of the Data Results Processor (DRP) which formats the data into a context required by the user.

FIG. 29. A diagram showing an example web page, and how data locations are defined.

FIG. 30. A diagram showing timing properties to load a page into a display device such as a world wide web browser; properties of human access to a world wide web page; and properties of non-human access to a world wide web page.

FIG. 31. A diagram showing particular data identifiers to define the data location.

FIG. 32. Page Hierarchy with Image Maps.

FIG. 33. A diagram showing methods employed to analyze hit signatures

FIG. 34. A diagram showing signature proximity values from which access origin probabilities can be determined.

FIG. 35. A diagram showing a hit index.

FIG. 36. A diagram showing knowledge sharing clervers connected on a network.

FIG. 37. A diagram showing adaptive stores interconnected in a number of independent networks.

FIG. 38. A diagram illustrating an example of how the FIG. 36 interconnected adaptive stores interoperate.

FIG. 39. A diagram illustrating a further example of how the FIG. 36 interconnected adaptive stores interoperate.

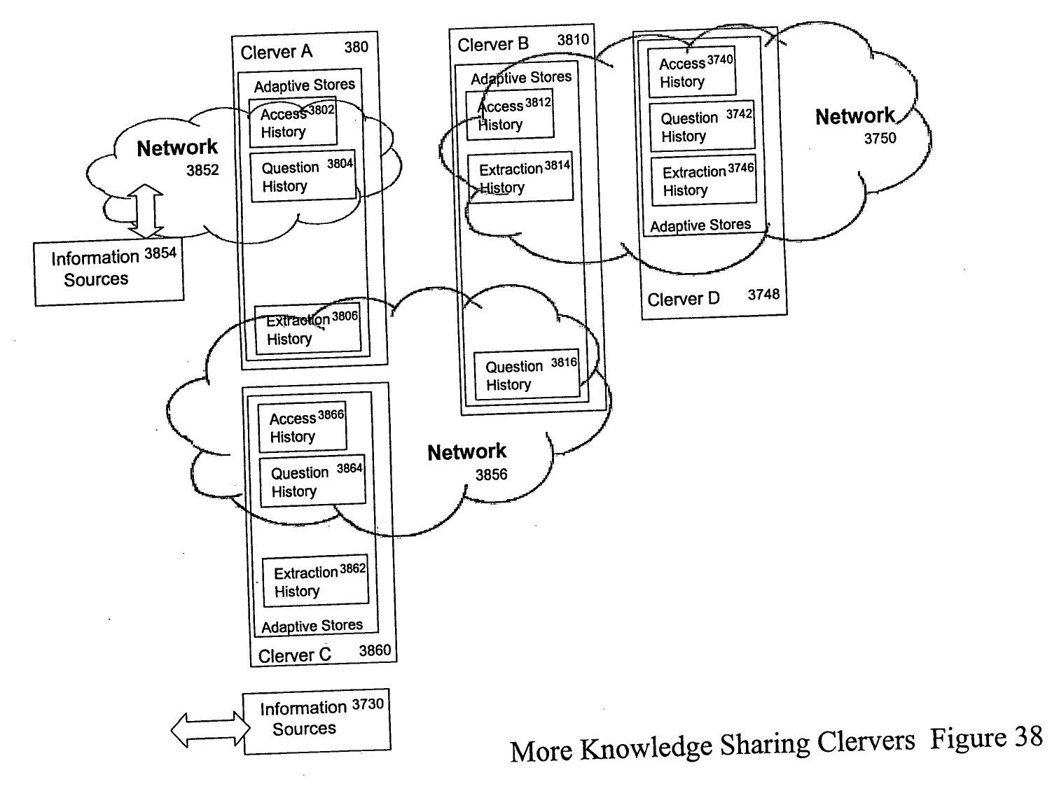

### DETAILED DESCRIPTION

In accordance with one broad aspect, the present invention provides a method executing on one or more computers to follow data into a repository based on data links and locator information provided by a user and/or from the repository, and extracting the data. The extracted data may be analyzed and optionally compared with other contextually similar data.

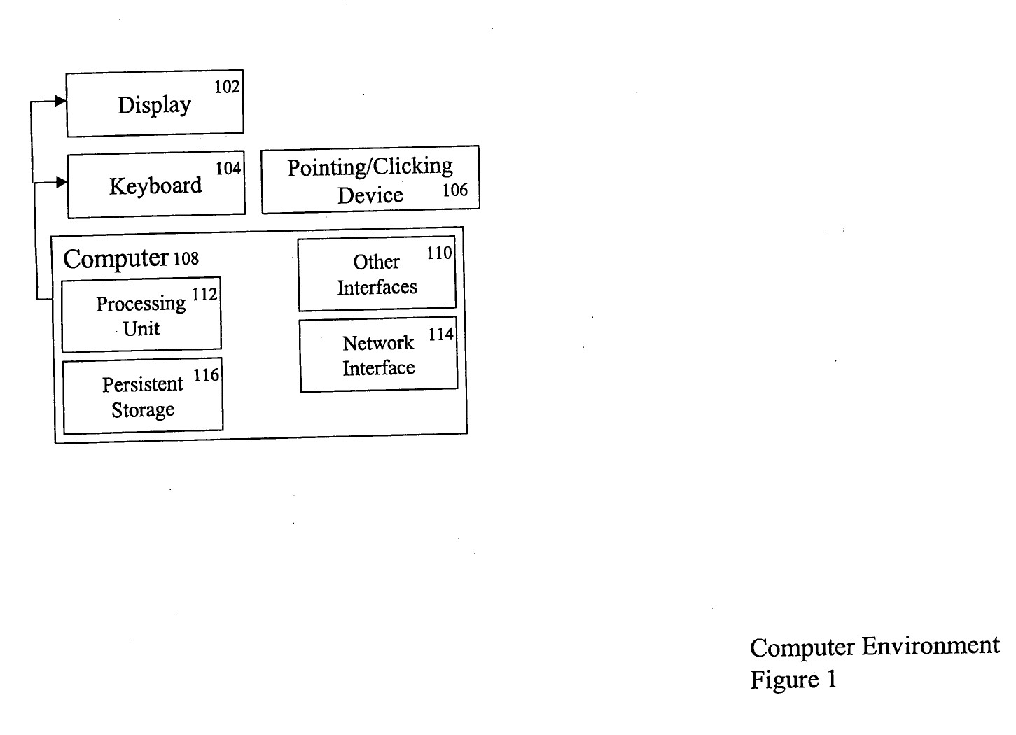

As used herein, the term “computer” is meant broadly and not restrictively, to include any device or machine capable of accepting data, applying prescribed processes to the data, and supplying results of the processes. In accordance with some embodiments, the methods described herein are performed by a programmed and programmable computer of the type that is well known in the art, an example of which is shown in FIG. 1.

The computer system 108 shown in FIG. 1 has a display monitor 102, a keyboard 104, a pointing/clicking device 106, a processing unit 112, a communication or network interface 114 (e.g., modem; ethernet adapter), other interfaces consistent with the application of the embodiment 110 and an adaptive persistent storage device 116. The adaptive storage 116 includes a storage area for the storage of computer program code and for the storage of data and could be in the form of magnetic media such as floppy disks or hard disks, optical media such as CD-ROM or other forms.

The processor is connected to the display 102, the keyboard 104, the point/clicking device 106, the interface 114, 110 and the storage device 116. The interface 114, 110 provides a channel for communication with other computers and data sources linked together in a network of systems or other apparatus capable of storing data and providing access to the stored data. In some embodiments, the network is the Internet (including the world wide web) and/or one or more intranets As used herein, “persistent storage” 116 includes any form of data storage including “adaptive storage” and “neural storage.” Data held in storage 116 may be represented by a plurality of and combination of forms such as compressed, encoded, encrypted and bare (i.e., unchanged).

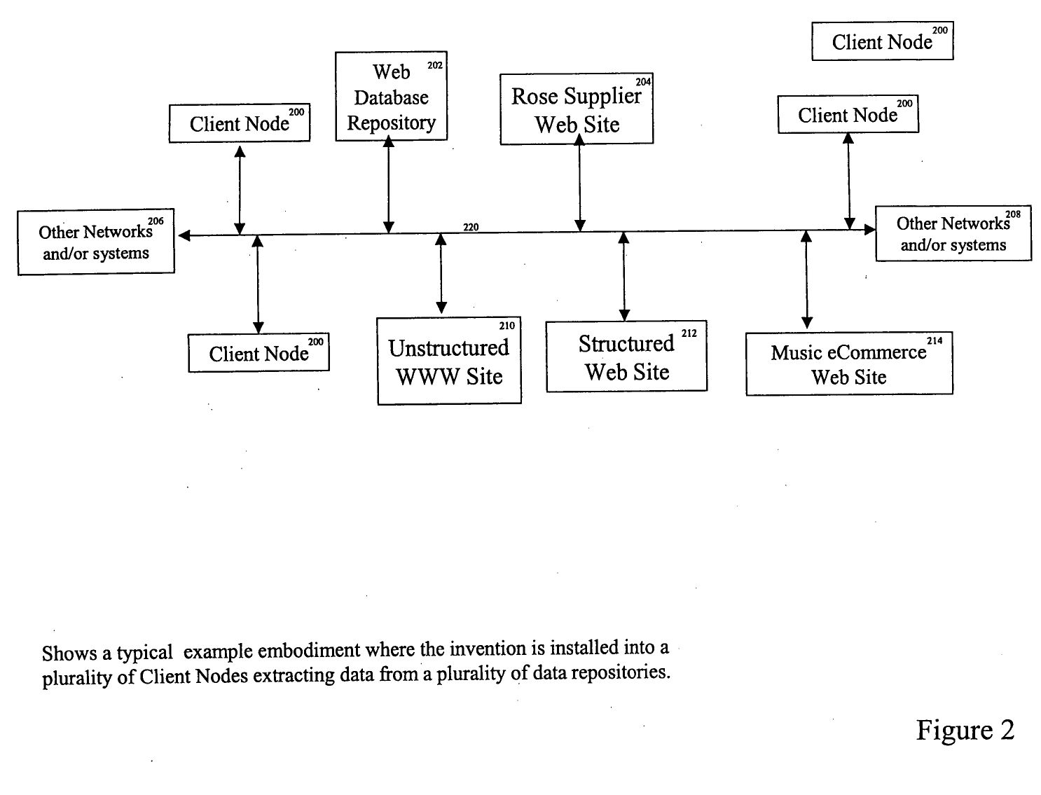

Referring to FIG. 2, client nodes 200 and representative data sources 202, 204, 210, 212, 214 are interconnected via a network connection 220. Although the client nodes 200 are shown separately from the data sources 202, 204, 210, 212, 214 any node connected to the network may function as either or both client of node and data source and may act either independently or in concert with other interconnected client nodes and data sources. For example, some or all of the nodes 200 may be any computer. In a typical embodiment, client nodes 200 include components to execute a software program, have one or more input devices such as a keyboard and mouse, one or more output devices such as a display and printer and the ability to connect to a network such as the world wide web.

The data sources may contain structured or unstructured data. Examples of structured data include data in databases supporting the Structured Query Language (SQL) and repositories in which data is stored in a predefined manner, such as with predictive delimiting keys or tags. Examples of unstructured data sources include repositories containing text in natural language, world wide web pages and data that is subject to unknown or unpredictable change. Examples of natural language include nominally unstructured texts written in English and/or other languages commonly spoken or written. Examples of data subject to unknown changes include world wide web sites containing weather forecasts; where the time and nature of the change is unpredictable and unknown. Examples of semi-structured, unstructured and rapidly changing data sources exist on the world wide web where data is often generated from databases and with a changing visual representation.

A client node 200 employs an identification/extraction specification to perform operations to identify and extract data from the data repositories. A simple example is discussed, to extract pricing information from three URL's containing text, as shown below:
http://www.a.com/a.htm: “3 burgers, two fries and a large soda: $4.99”
http://www.b.com/b.htm “Free large soda, 2 fries with three burgers, unbeatable value at $4.87”
http://www.c.com/c.htm “$5.55 gets you large soda, 2 terrific fries and 3 beefy burgers”

The specification includes the location of the data on the page, or information usable to determine the location of the data and information for extracting the data. In the above example, certain defined keywords are used to locate a section of text of interest. In the above example, a search is made for keywords ‘burger’, ‘fries’, ‘soda’ and a numeric price of the format $x.yz. In addition, a search is also made for the presence of a quantity operator that may precede the keyword such as ‘three burgers’. Keyword comparisons are notorious in the art for being slow and inaccurate. For example, a search on the keyword “burger” would not match the contextually identical term “Big Mac”. It is a common practice to perform what are known as “partial matches” and such a partial match on the term “burger” would yield a correct match in the sentence “. . . beefy burgers”, the word “hamburger” but would also incorrectly match “burgermeister”, “burgerstrasse” and other terms. As used herein, the term keyword refers to a singular or plurality of combinations of terms, identifiers, phrases, sentences, words and such equivalents that are commonly used as a part of Natural Language.

Data locators may be specified in any of a number of forms, examples of which are shown below:

| Type | Description |
|---|---|
| Cartesian | The location of the data is specified as a set of Cartesian co- |
| | ordinates describing a rectangle encompassing the text or |
| | data of interest. This is generally used only when the data |
| | locations are unchanging. |
| | E.g.: 10, 5 600, 70 could be used to define all text from line |
| | 10, character position 5 to line 600, character position 70. The |
| | meaning of the co-ordinates is entirely dependant on the |
| | specific embodiment, the nature of the data being extracted |
| | and the requirements of the user(s). |
| Block | The location of data of interest is specified as a set of |
| | keywords or keyword sequences describing the start and end |
| | of a block of text. Thus the sequence “Find my text to |
| | identify.” could be identified using the start keyword Find |
| | and the end keyword ‘.’ (period). This technique can be |
| | used to track text blocks when the location of the blocks is |
| | not fixed. |
| Offset | An offset in the form of Cartesian co-ordinates, character |
| | offset, byte offset, or keyword sequence can be used |
| | singularly or in combination to define an offset from a known |
| | location or from a previously defined data location. |

Data locators may be specified without regard for alphabetic capitalization of the text and can be combined with Boolean operators (and, or). Each identifier may follow URL's contained in the text block. Each data locator may have a plurality of actions that would be performed in the event that the locator was matched. Well-known text processing techniques—such as regular expressions, Prolog, Lisp, Lex and yacc—may be employed, as well as “adaptive contextual matching” devices and methods as described in greater detail herein.

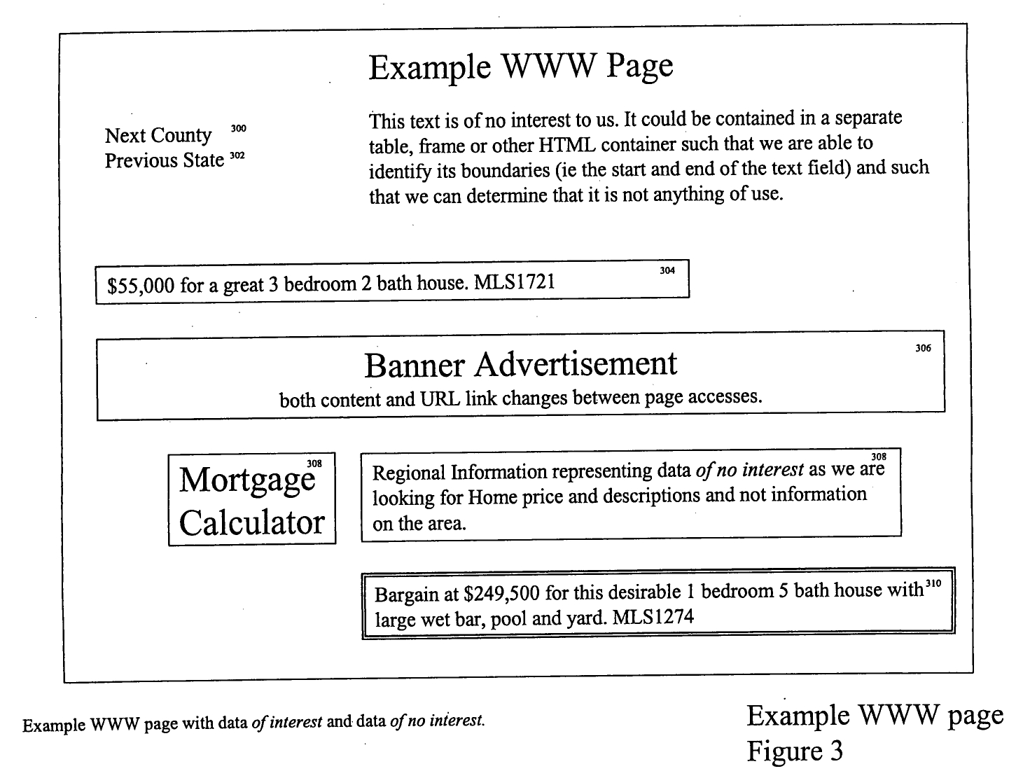

Describing the locations of data may utilize (or even require) a mixture of the above types, and the nature of the descriptions used may vary between embodiments. An example of how a plurality of data locations are described is shown in FIG. 3, which includes four data items of interest. Items 300 and 302 are links to other pages of interest, to be followed. Items 304 and 310 are text blocks of interest that are to be identified for extraction. Items 306 and 308 contain information that is to be disregarded. The content of Items 304 and 310 and the URL's pointed to by Items 300 and 302 may change between accesses to the page. Item 300 is identified by a data locator looking for the keyword “Next” from the start of the page and the action(s) associated with the keyword are
(a) extract and store the URL as a URL to follow; and
(b) set an internal data cursor for the start of the next locator search.

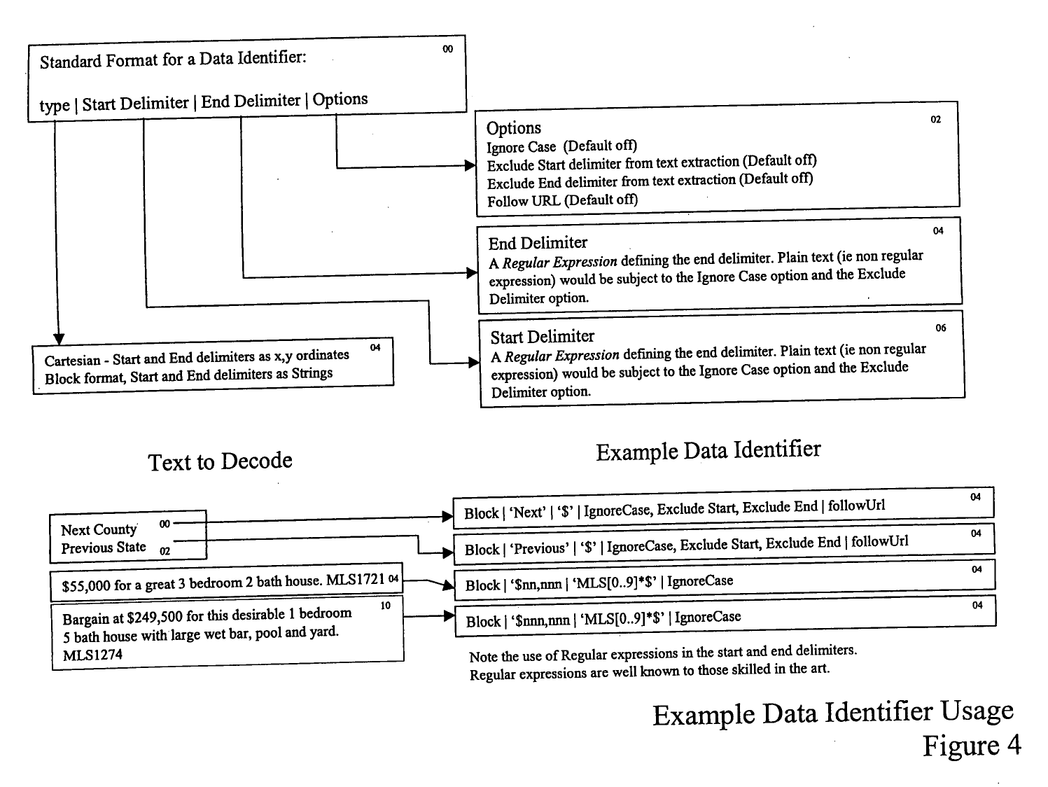

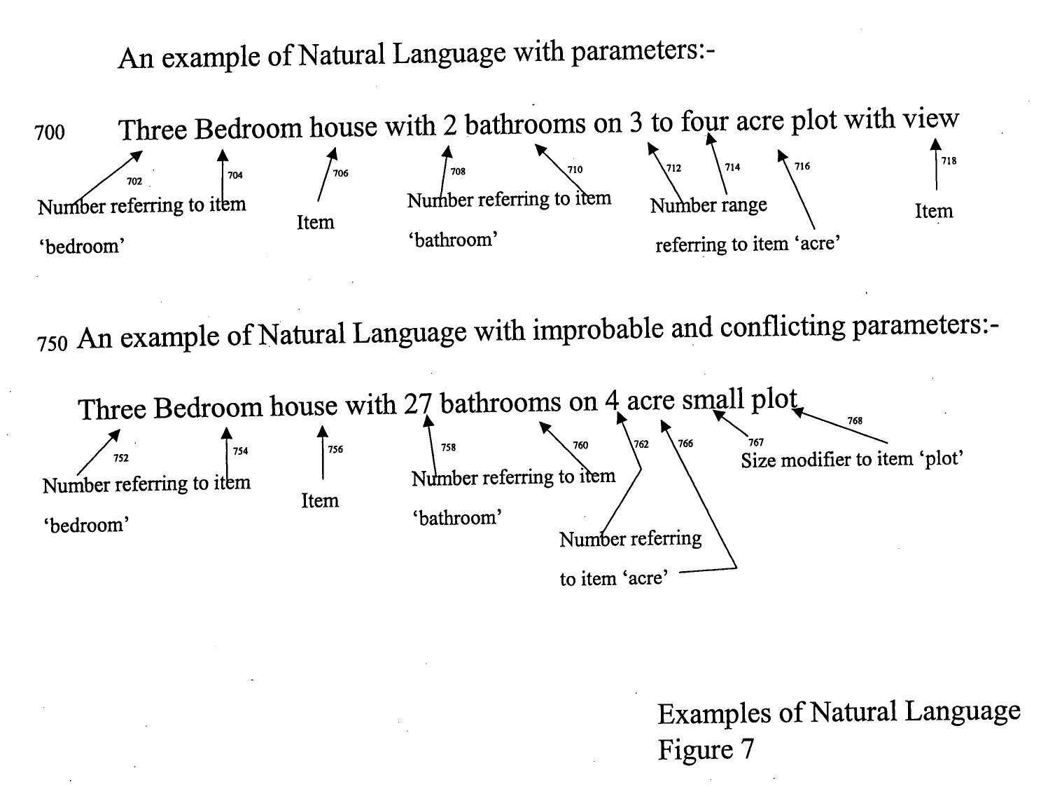

Item 302 is identified by a data locator looking for the keyword “next” from the data cursor and the action(s) associated with the keyword are the same as (a) and (b) above. The keyword “next” in this example may also include any contextually similar term The boundaries of the block of text A04 cannot be determined by Cartesian geometry, as the text data will change and thus a data cursor is used to determine the starting point for a search. It is known that the text block starts with a numeric field of a currency type ($55,000) and ends with the keyword MLS1721. Thus, the block start is set to begin with and include a currency type keyword and to end with and include a field of the type “MLSnnnn” where nnnn is an unknown amount of numeric characters. The data cursor is set to the end of the MLSnnn field. Such field delimiting is well known to those skilled in the art. The text block 310 is located in a similar manner as text block 304, as the subjective words “bargain at” in block 310 are to be disregarded. The data identifiers used to describe these data blocks are shown in FIG. 4. The manner in which the text and links are examined is described later with reference to FIG. 7.

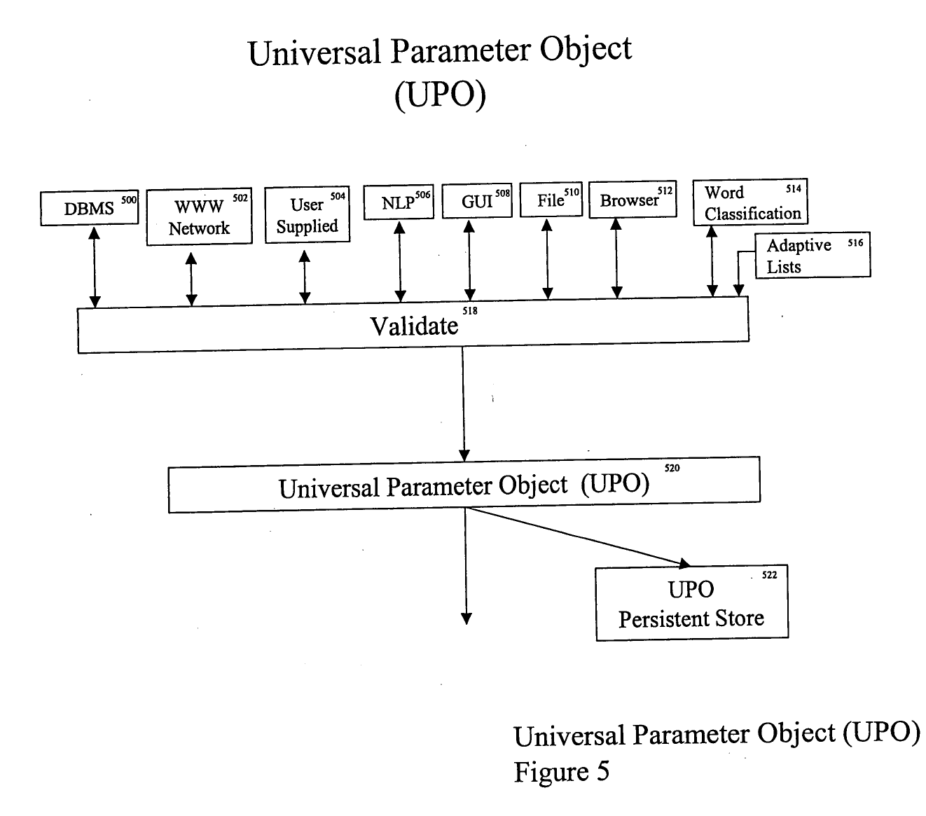

The keywords are parameters to be included in a Universal Parameter Object (UPO). An embodiment of a UPO is illustrated in FIG. 5. Details of the context appropriate to the parameters may be sourced from a plurality of sources such as a Database Management System (DBMS) 500, the world wide web 502, User Supplied Object 504, Natural Language Processor (NLP) 506, a Graphical User Interface (GUI) 508, a data file 510 containing an existing UPO or containing flat data or other data of expected context, a Browser 512, or even an existing UPO contained in an Adaptive Store 516.

A world wide web page from the world wide web 502 could contain default information or other parameters that could be used by a user without the need to explicitly define such parameters. In one embodiment, a web site (e.g., www.findbase.com) is accessed to retrieve parameters and other information for the UPO, thus assisting an unskilled user who may not be able to easily determine the exact nature and location of the parameters. This technique also allows for a plurality of users to share a set of parameters. Data indicating the context is validated 518 against validation criteria indicated by the context of the original parameters. Validated parameters forming a UPO 520 can be stored in a plurality of persistent object repositories 522 with a unique identification code such as an alphanumeric name or index key.

In some embodiments, the GUI 508 is provided to facilitate correct operation of the UPO. For example, the GUI may include a visual display, a pointing device such as a mouse, an entry device such as a keyboard, local storage for data and program and a network connection.

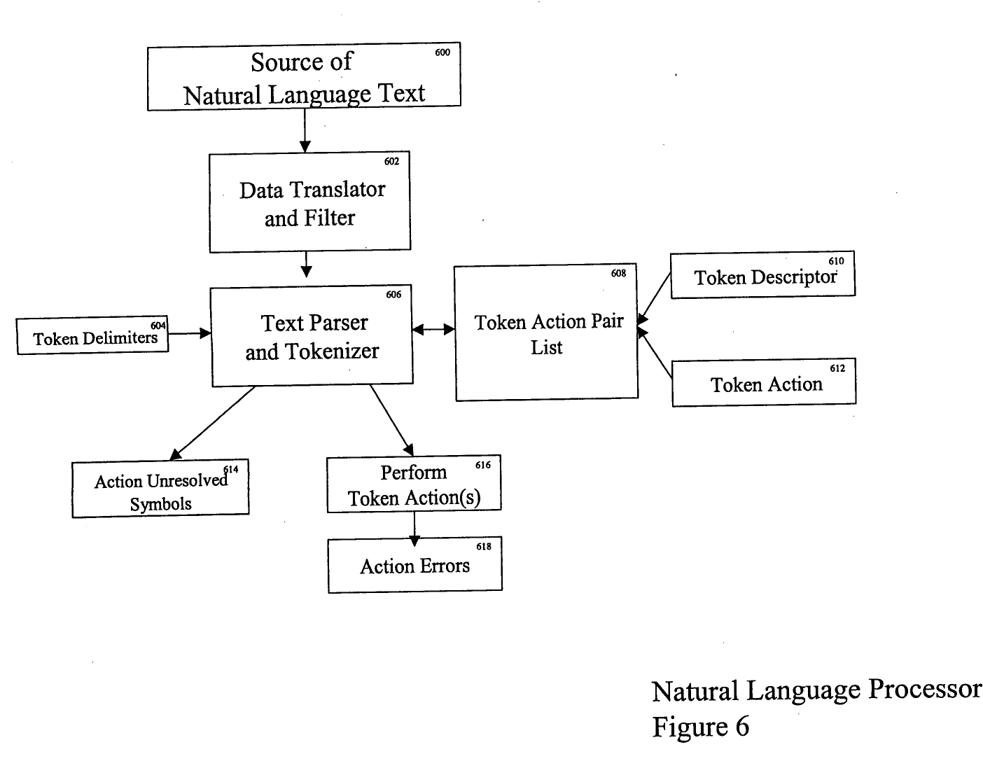

The NLP 506 may be employed to decode and extract contextual meaning from text originating as parameter definitions or text extracted from a repository. FIG. 6 shows the components for the Natural Language Processor which can form part of a UPO 320, part of a GUI 308 or function in an independent manner such as taking textual input from any data source such as a data file, speech, a Palm or other handheld computer. The NLP converts words, commands and parameters contained in Natural Language into a format for storage comparison and execution by a software program, an example of which could be the embodiment of this invention. Reference to FIG. 5 shows an example of commands and parameters contained in Natural Language. It should be noted that the commands and parameters in the Natural Language could be contradictory and conflicting and such contradictions and conflicts are resolved with a Natural Language Processor (FIG. 5). The meaning of Natural Language Text (NLT) is dependent on the context applied when the text is translated into its component parts. The first example of NLT, 700, shows a sentence in the English language describing some characteristics of a house. Components of the sentence, called tokens, are separated from each other by a delimiter character which in this instance is a single space or a plurality of space. Those versed in the art will recognize that other delimiter characters are used in the English language and the space character could easily be one or a plurality of these characters. The sentence can be immediately recognized as containing a description of a dwelling with a number of bedrooms 702, 704, a type of dwelling 706, a number of bathrooms 708, 710, a numeric range 712, 714 referring to an item 716 and thence another item 718. Contextual meaning is given to the tokens by the individual embodiments such that they would allow for “correct operation” of the parts of the components.

Referring back to FIG. 6, before context and meaning are determined, a text translator 602 is used to provide any initial textual translation such as the removal of presentational formatting. The text translator 602 receives natural language from a plurality of sources such as a data file containing text, a GUI, a UPO (FIG. 5), a DBMS. The text translator performs natural language translations to convert the text into a form that the text parser and tokenizer (TPT) 606 expects. The TPT 606 splits the text into tokens, each token separated from adjacent tokens by delimiter characters or sequences of characters know as character strings contained in a delimiter list 604. Such tokenization is well known to those knowledgeable in the art. Each token is compared with token elements contained in a Token Action Pair List (TAPL) 608 and if a match is found, the action or actions defined in the corresponding element in the TAPL 608 are performed. Tokens that have no match in the TAPL 608 are ignored or, alternatively, an action or actions are performed on the tokens dependent on the requirements of the embodiment of the invention. The process continues until all tokens have been compared with those contained in the TAPL 608. An example of contradictory and conflicting tokens (i.e., is shown in 650), the meaning of which is determined by the actions contained in the entries in the TAPL 608. The conflicts are typically resolved when all tokens have been processed by the TPT 606. Example token actions include setting various visual characteristics in a GUI, setting parameters in a file, or any other action that converts the context and meaning of the natural language into a context required by other components of the invention (which are described in other figures).

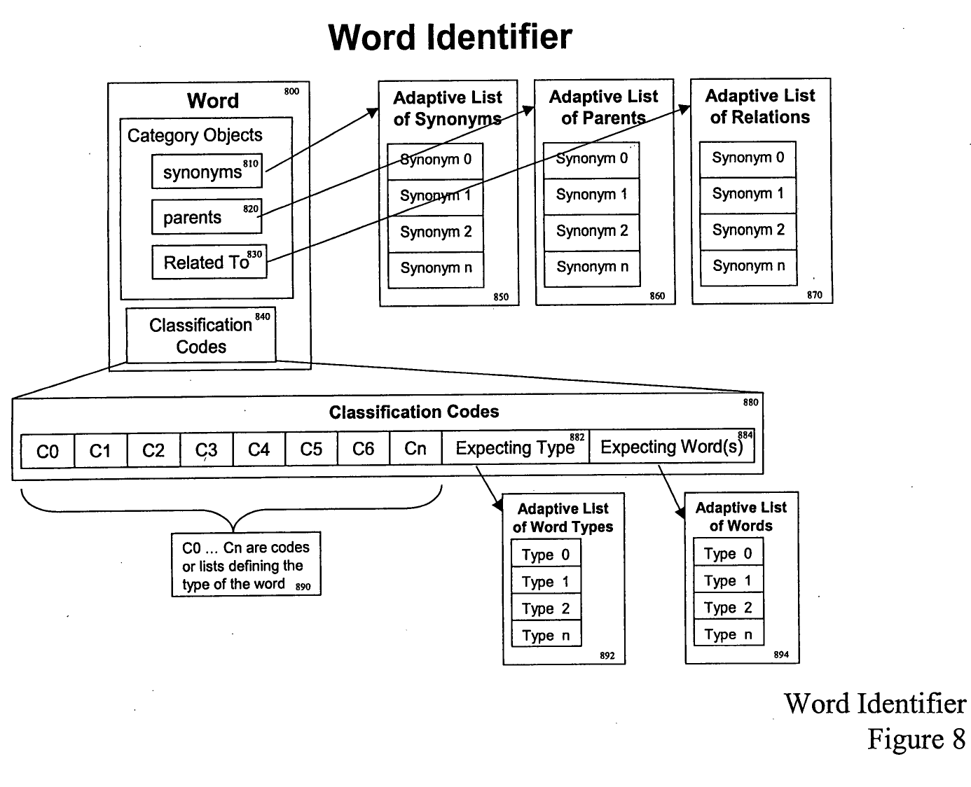

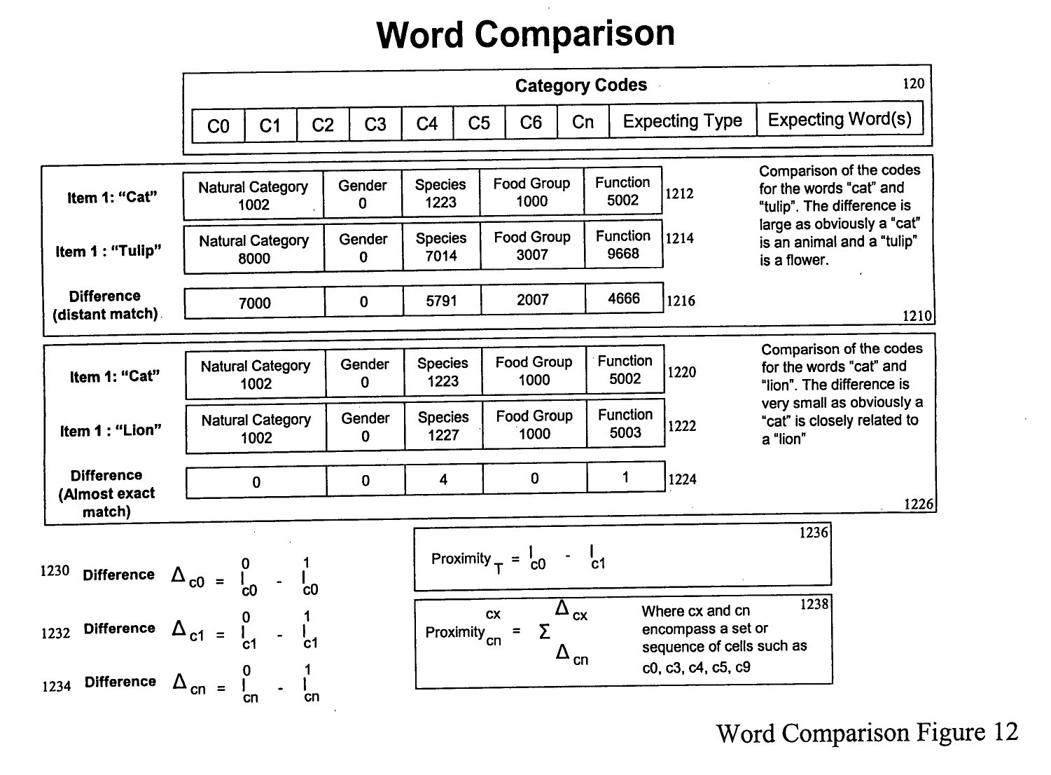

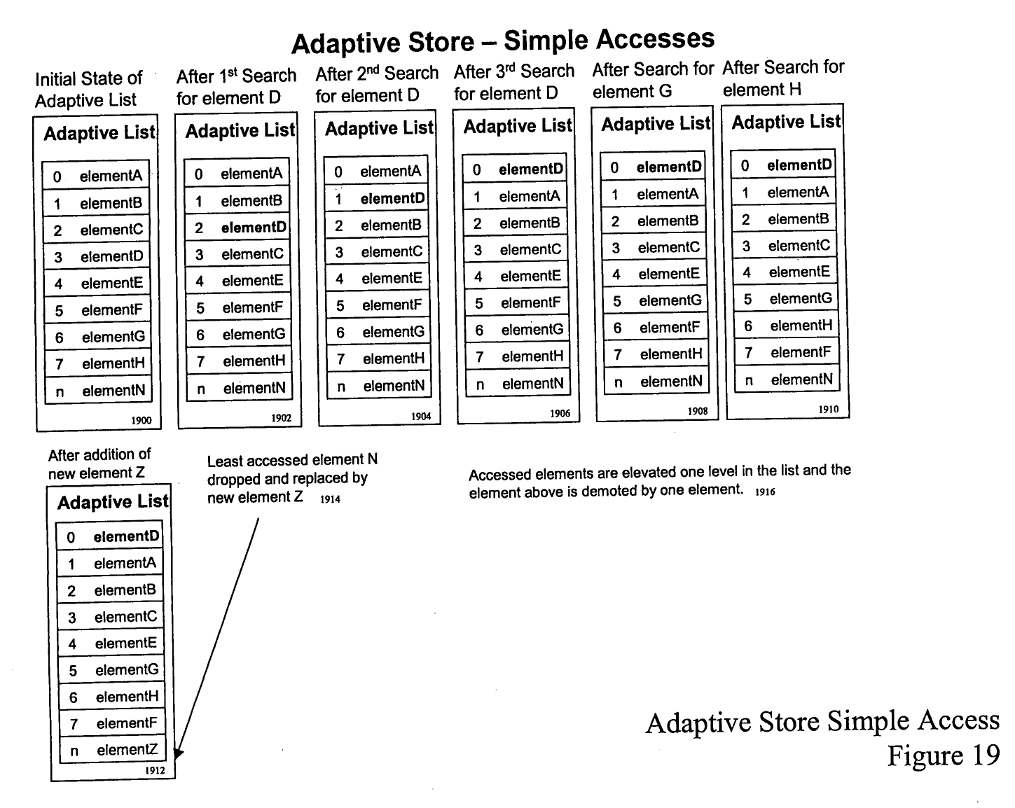

With reference to FIG. 8, TAPL comparisons can also use Word Identifiers that indicate the meaning of the word and any actions that are to be taken relating to said word. Item 800 is a Word Identifier comprised of a number of categories 810, 820, 830 and Word Classification Codes 840. Although three categories are shown, there is no theoretical limit on the number and types of categories, and the requirements of specific embodiments should be considered. For example, the category “synonym” 810 is a reference to an Adaptive list of Synonyms 850 for the word 800. The use of an Adaptive List (FIG. 19) enables the synonyms contained or referenced in 850 to be relevant to the needs of the specific embodiment by making more prominent (or even only keeping) those synonyms that are frequently used. The number of possible synonyms can be large, duplicate and reference yet more synonyms. The Adaptive Lists 850, 860, 870, 89, 894 makes more prominent those elements relevant to the context of the word defined by Word Identifier 800. Other categories are shown, a reference to a list of parents 850 and a reference to a list of relations 870. Although Adaptive Lists may be used in some embodiments, other embodiments utilize other forms of lists such as an SQL or hash table. The Classification Codes 880 indicate the meaning and knowledge that is encapsulated in the word. The “expecting type” 882, “expecting words” 884, “Relations” 870 lists when used singularly or in combination provide contextual information for Associative Comparisons (FIG. 12).

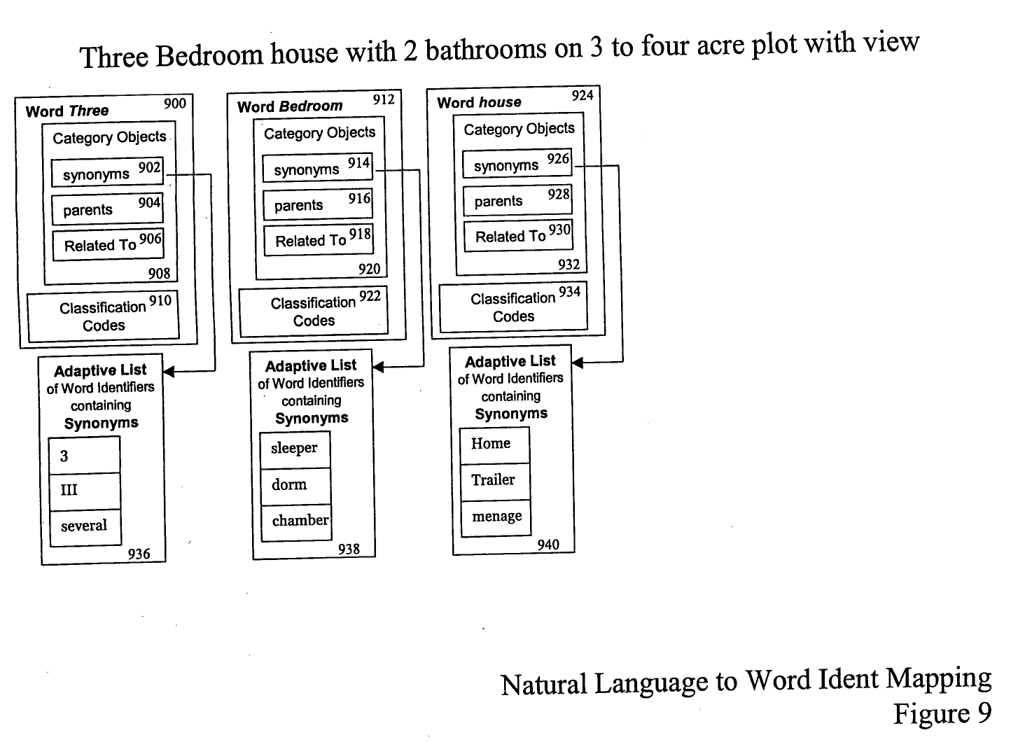

With reference to FIG. 9, it is seen that the first three words of the example sentence 700 (FIG. 7) contained by Word Identifiers 900, 912 and 924. An adaptive list 936 defines some of the synonyms for the word “three” contained in 900. The number or nature of the synonyms should not be considered limited to those shown in 936, 938 and 940. The other references 904, 906, 914, 916, 918, 926, 928, 930 are defined in accordance with the requirements of the specific embodiment. There are very few words that are not related to other words and, thus, references such as 904, 906, 914, 916, 918, 926, 928, 930 can become very large.

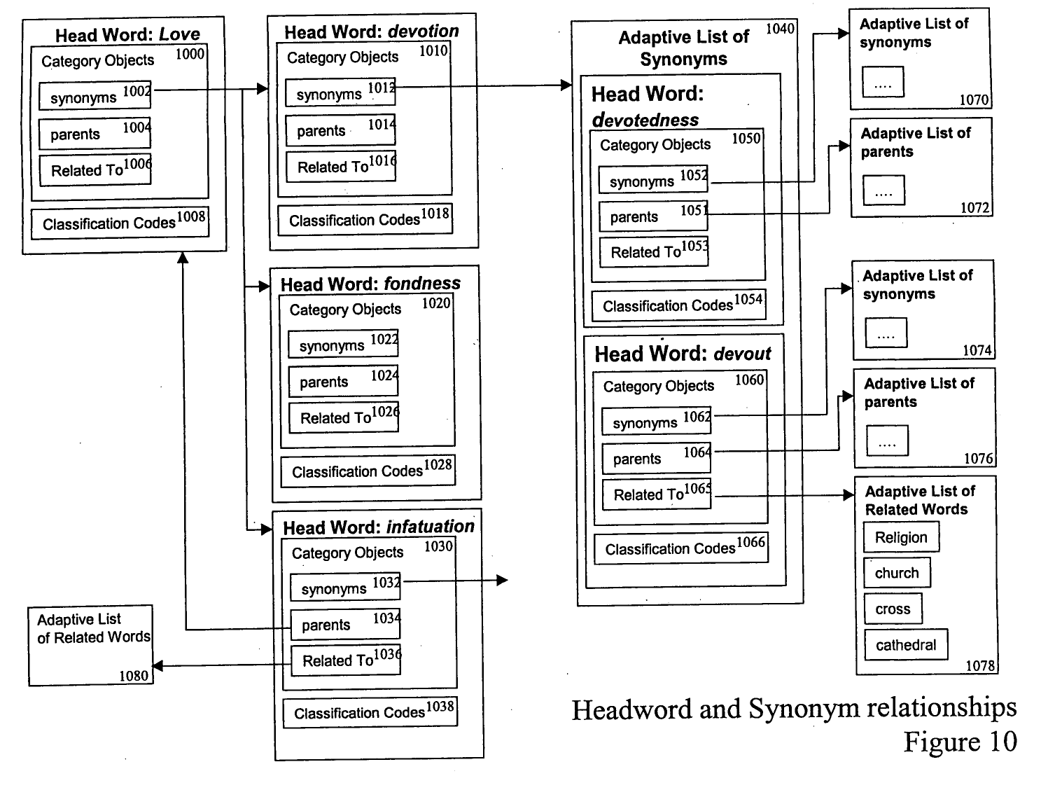

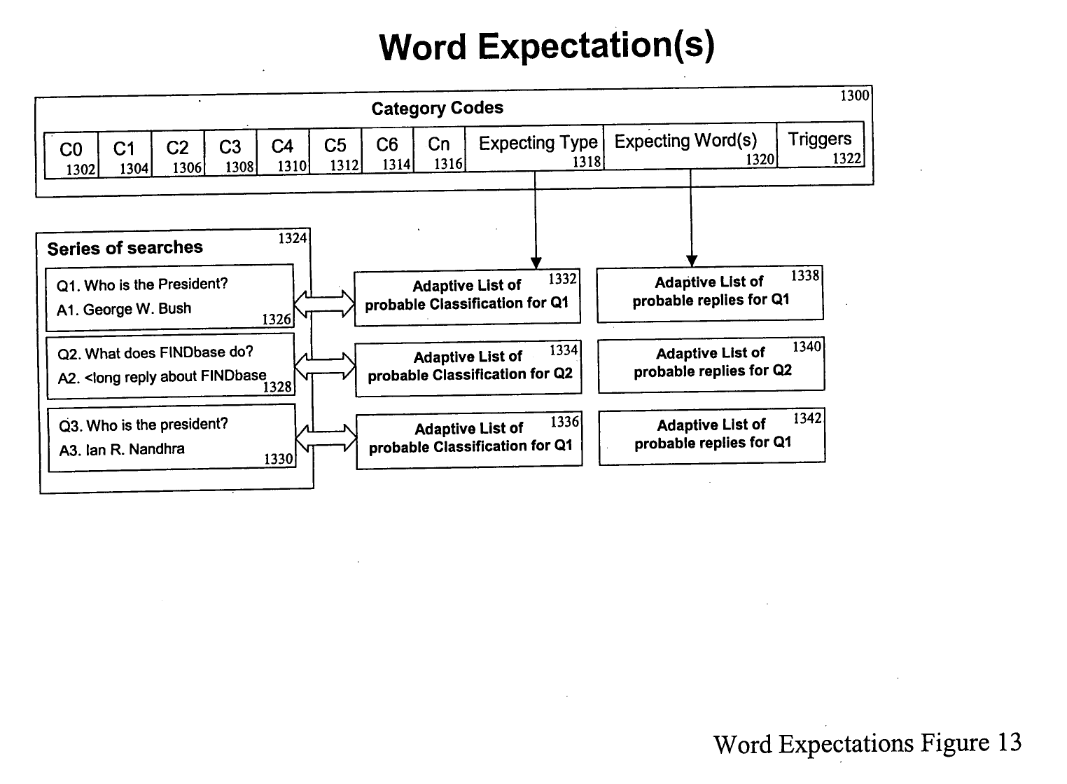

With reference to FIG. 10, it is seen how these references can spread. For example, the word “love” is considered as a “Head Word” in so far as no other words are defined that reference it. Three synonyms for “love” are shown 1010, 1020, 1030, and these in turn point to other words or lists of words. The word “devotion” 1010 having parent “love” 1000, is considered the “head word” for the words “devotedness” 1040 and “devout” 1060, which in turn acts as the “head word” for the word “religion” in list 1078. A “head word” can be considered as the starting point for lists of related words and that each headword can be referenced by a plurality of other headwords or keywords. Clearly, the number and type of the relationships is limited only by the needs of the specific embodiment. The relationship between these words is defined or learned as shown, for example, in FIGS. 12 and 13.

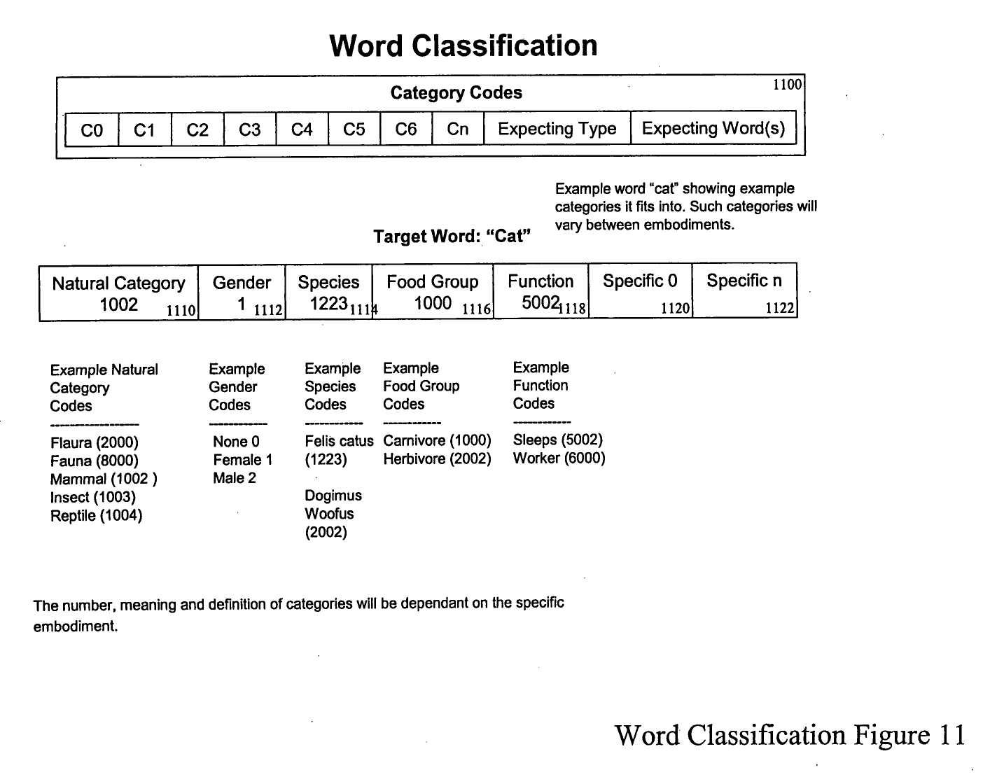

FIG. 11 illustrates an example series of classification codes as applied to the word “cat” and these codes may vary between embodiments. FIG. 11 supplies meaning to the word “cat” as a series of numbers representing general classifications or groupings that have relevance to the specific embodiment. In the example, a cat is encompassed by categories 1110, 1112, 1114, 1116, 1118, 1120, 1122 defining a cat as a Mammal (code 1002), a female (code 1), of species “Felis Catus” (code 1223), a carnivore (code 1000), with a function “sleeps” (code 5002). Although other categories 1120, 1120 are not specified, the number and type of these categories is theoretically not limited.

The category codes in FIG. 11 provide a numerical representation of the meaning of the word that facilitates fast comparisons with other words utilizing similar and contextually compatible Classifications. In this way, words with similar classifications can be considered contextually similar; words with identical classification codes can be considered contextually equivalent. The term “similar” refers to the difference between the contextually equivalent classification codes in the words being compared. Such numerical comparisons provide the means to show that a “cat” is not a “tulip” and also that a “cat” is very close to a “lion”. Embodiments using the NLP 500 can identify contextual contradictions such as “a cat is a tulip” and “lions eat tulips” while recognizing contextually correct similarities such as “cats are lions”. Quantifying the level of these similarities with existing techniques such as keyword, word comparisons or Regular Expressions is extraordinarily difficult, unwieldy or even impossible.

With reference to FIG. 12, it is seen that 1210 shows that the numerical difference 1216 between the words “cat” 1212 and “tulip” 1214 is large. Although the meaning of the difference varies between embodiments, the size of the difference 1210 indicates a high probability that a “cat” 1212 is not a “tulip” 1214 and a correspondingly small value giving a lower probability that a “cat” is a “tulip.” Reference to the comparison 1226 shows the difference 1224 between the words “cat” 1220 and “lion” 1222. In this example, the difference is small indicating a high probability that a “cat” 1220 is in some way related or connected to “lion” 1222. The term function 1230 defines the difference equation for categories c0 and c0 in for Items I0 and I1. The term function 1232 defines the difference equation for categories c1 and c1 in for Items I0 and I1 and the term function 1234 defines the difference equation for categories cn and cn for Items I0 and I1. The number of terms is dependent on the number of classification codes—which may vary between contextually similar words and specific embodiments. The term 1236 defines the proximity between classification codes Ic0 and Ic1. The term 1238 defines the proximity between the classification codes cx to cn where Δ_{cx} and Δ_{cn} are a set of cells 1238.

With reference to FIG. 13, it is seen that contextual meaning is given to Word Classifications 1300 in the form of “expecting type” 1318, “expecting words” 1320 and “trigger” 1322 that when used singularly or in combination can develop adaptive lists of words of expected classifications 1332, 1334, 1336 and adaptive lists of probable replies 1338, 1340, 1342. 1324 shows a series of example questions.

In this example, a UPO 520 (FIG. 5) is constructed with parameters such as usable to identify and extract information for the question 1326 “Who is the President?”. In this example, Word Identifiers (FIG. 8) and respective Word Classifications (FIG. 11) are set to contain “the United States of America” giving contextual information. Word Classification comparison of the extracted data shows a very high probability that “George W. Bush” is the correct answer. The way that this reply is presented varies among embodiments. In accordance with use embodiment values of the difference terms 1230, 1232, 1234, 1236, 1238 are used singularly or in combination to provide an indication of the accuracy of the result. The Word Identifiers (FIG. 8) and respective Word Classifications (FIG. 11) for the question Q1 (1326) are stored in an Adaptive List 1332.

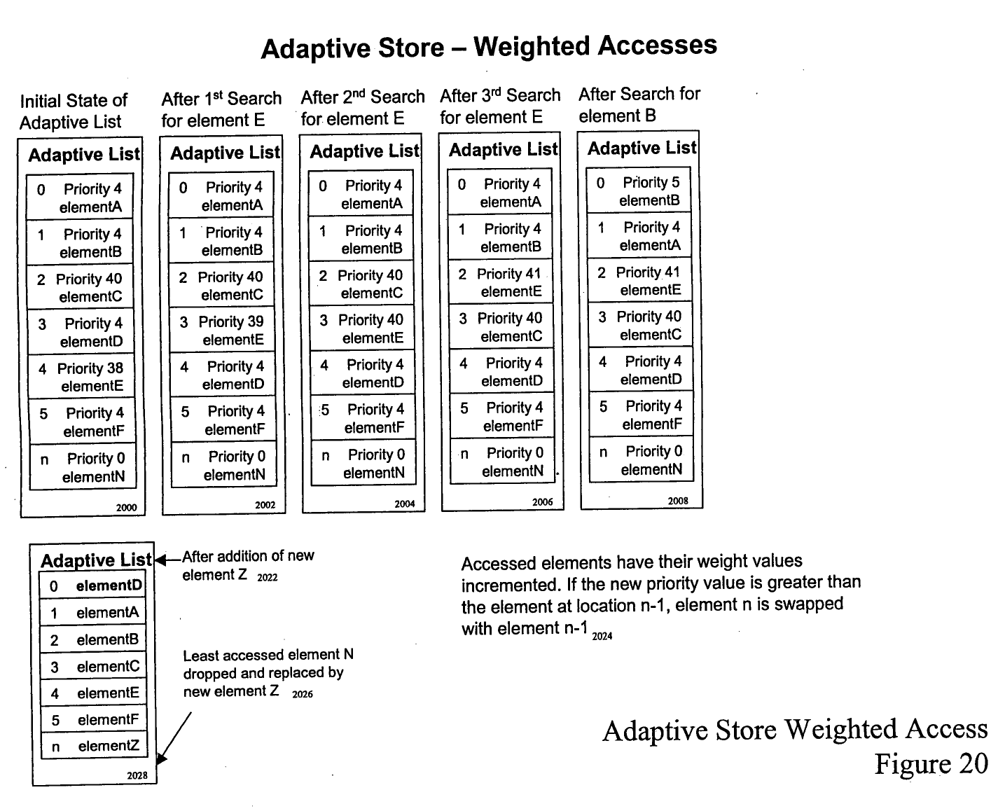

The Word Identifiers (FIG. 8) and their respective Word Classifications (FIG. 11) for the answer A1 (1326) are stored in an Adaptive List 1338. Question Q2 (1328) now changes context contained in 1332 and 1338 from the United States of America. A UPO (FIG. 5) is constructed with parameters such as are required to identify and extract information for the question 1328 “What does FINDbase do?“The Word Identifiers (FIG. 8) and their respective Word Classifications (FIG. 11) for the answer A1 (1328) are stored in an Adaptive List 1340. The question “Who is the President” 1330 now has contextual relevancy encompassed in 1334 and 1340 that when used a Word Classification comparison of the extracted data shows a very high probability that “Ian R. Nandhra” is the correct answer. The adaptive lists 1332, 1338, 1334, 1340, 1336, 1342 gather Word Identifiers encompassing actual answers, probable answers and other information that matches the context and meaning of the questions and the answers supplied with the least probable information (in this instance Word Identifiers) being dropped from the List (this is described in greater detail later with reference to FIG. 20).

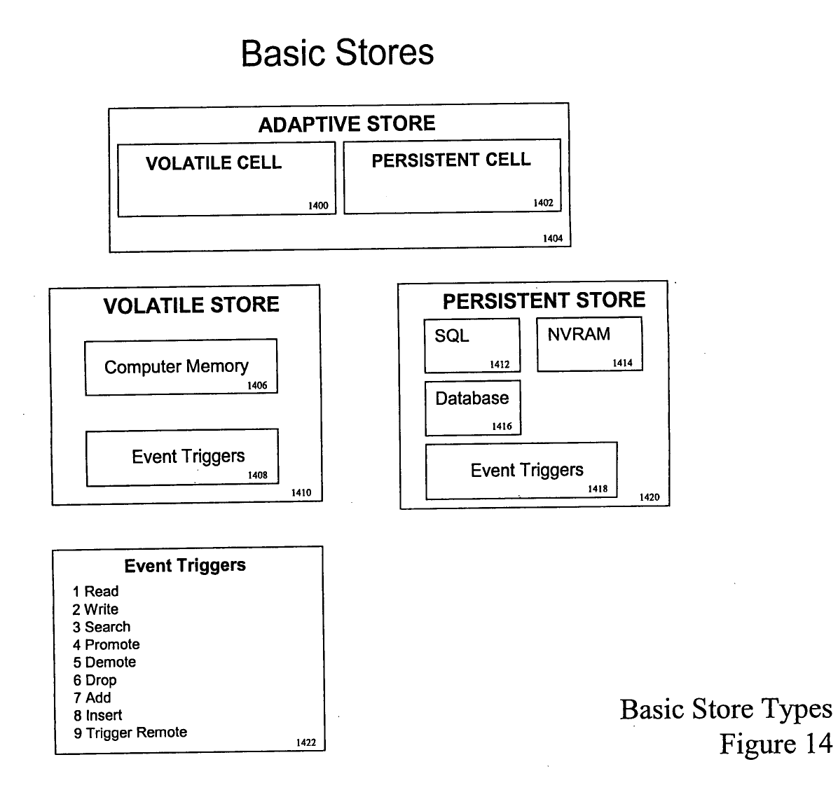

The use of Adaptive Lists results in faster accesses to the most relevant information. Reference to FIG. 14 shows another aspect of this invention—referred to as “Adaptive Stores” against other types of storage familiar to those versed in the art. A conventional volatile store lacks the ability to retain information stored therein for periods of time without power. A persistent store has the ability to retain information stored therein for periods of time with or without power. Volatile stores are typically very much faster than persistent stores and are preferred for rapid retrieval of small amounts of information. Persistent stores are typically very much slower than volatile stores but are preferred for storing large amounts of information. Persistent and volatile stores used in the art require the absolute location of a data item be known prior to its retrieval from the store. Finding an item of data in the store without knowledge of its absolute location requires that the store be searched from an initial starting position until the item is found. The time for such a search is dependent on such factors as the access speed of the store and the amount of data in the store. The closer the object of a search is to the initial starting position, the quicker it will be found. Storage devices typical of those used in the art also lack the ability to group similar items in close proximity in the store to enable faster discovery during a search. An “Adaptive Store” as referred to herein includes functionality that groups the most currently used data in the store (perhaps keeping only the most currently used data, to the exclusion of other data), thus greatly speeding up data searches and reducing the amount of irrelevant data in the store.

The Adaptive Store 1404 may include any combination of volatile stores 1400 and persistent stores 1402. These are special types of stores, termed a “cell”—reflecting the smaller amount of data and that the “cell” includes trigger mechanisms 1410, 1422 not found in conventional stores. In this example, the volatile cell 1410 is comprised of computer memory such as random access memory or any volatile memory device. The persistent cell 1420 in this example is comprised of an SQL 1412, NVRAM 1414 and a database 1416, in addition to the event trigger mechanism 1418.

Example event triggers 1422 access a singular or plurality of devices such as computer programs when certain conditions have occurred in the store. The conditions shown in 1422 vary among embodiments, but are not restricted to these examples. Each trigger 1422 has actions associated with it commensurate with the requirements of the specific embodiment. For example, such actions could be used to load data into other Adaptive Stores, load data, configure a UPO, etc. Actions associated with trigger 1424 are performed whenever an element is read from the store. Actions associated with trigger 1426 are performed whenever an element is written to the store. Actions associated with trigger 1428 are performed whenever an element is searched for in the store. Actions associated with trigger 1430 are performed whenever an element is promoted in the store. Actions associated with trigger 1432 are performed whenever an element is demoted in the store. Actions associated with trigger 1434 are performed whenever an element is dropped from the store. Actions associated with trigger 1436 are performed whenever an element is added to the store. Actions associated with trigger 1438 are performed whenever an element is inserted into the store. These triggers form the interactions between Adaptive Stores and Adaptive Lists as described elsewhere in this patent application.

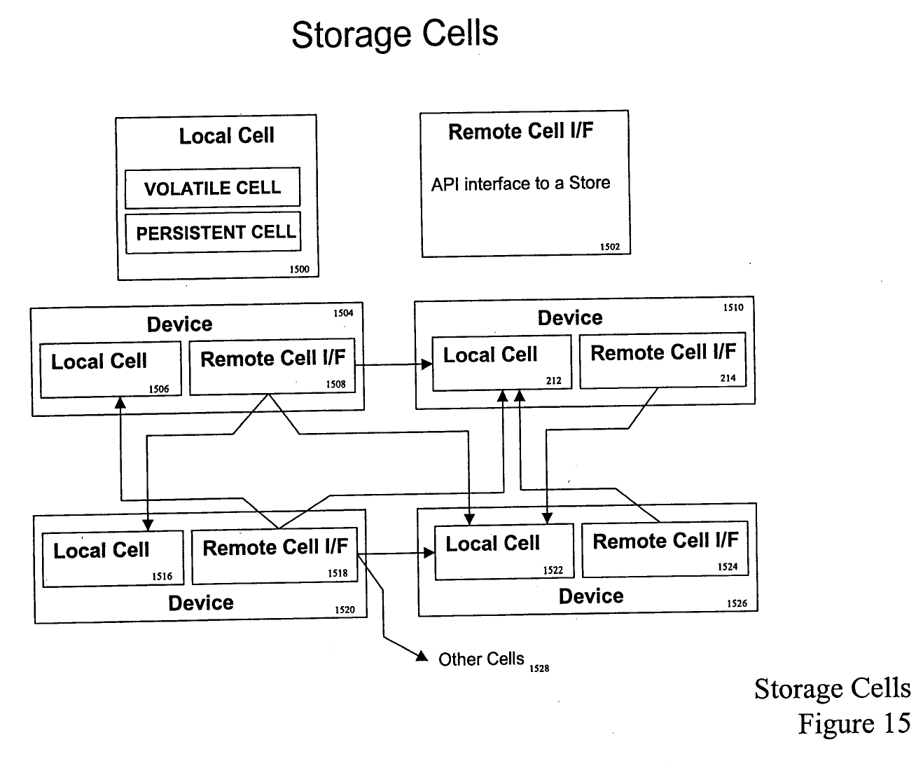

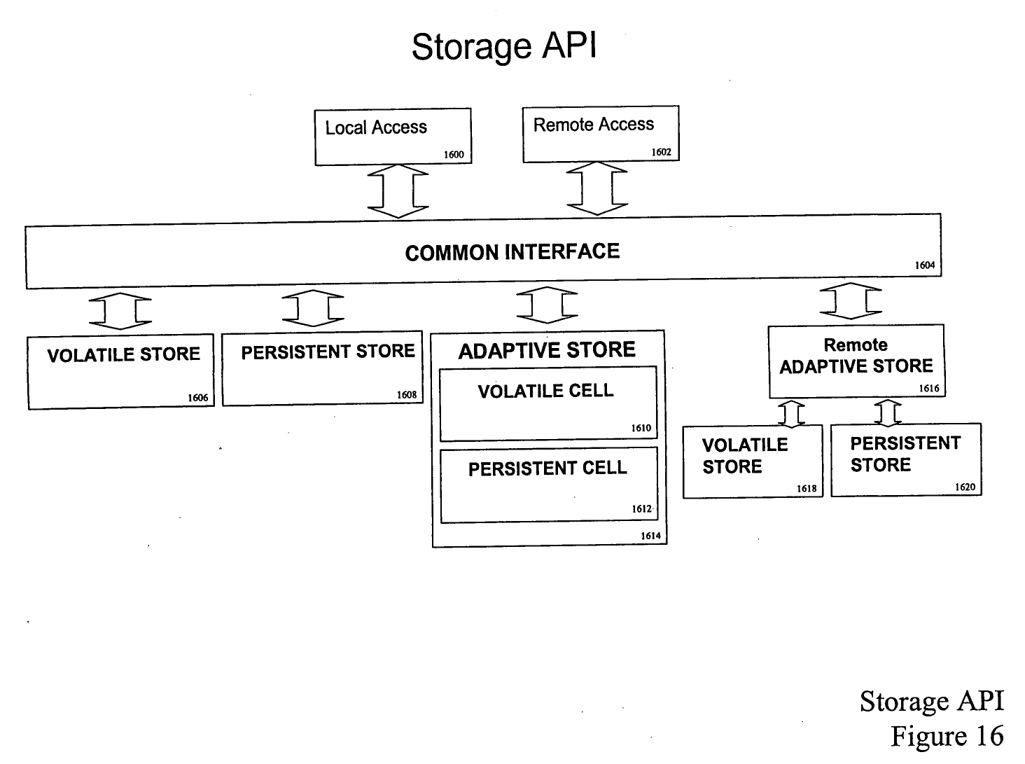

FIG. 15 illustrates interconnections of Volatile and persistent Adaptive Storage cells across a network and residing in the same system. A common interface 1604 (see FIG. 16, discussed later) allows remote and local cells to be accessed in the same way. Cells 1504, 1510, 1520 and 1526 are connected to other cells either locally or remotely, the exact nature of the interconnections being dynamically changeable and dependent on the requirements of the specific embodiments. In the FIG. 15 example, cell 1504 can access data in cell 1522 via the remote interface 1508. An Application Programming Interface (API) as illustrated in FIG. 16 addresses the incompatibilities and inconsistencies between various storage devices. Thus the Random Access Memory 1606 and the SQL 1608 and the Adaptive Store 1614 and the Remote Adaptive Store 1616 can all be accessed in the same way from local 1600 and remote (i.e., networked) 1602 locations.

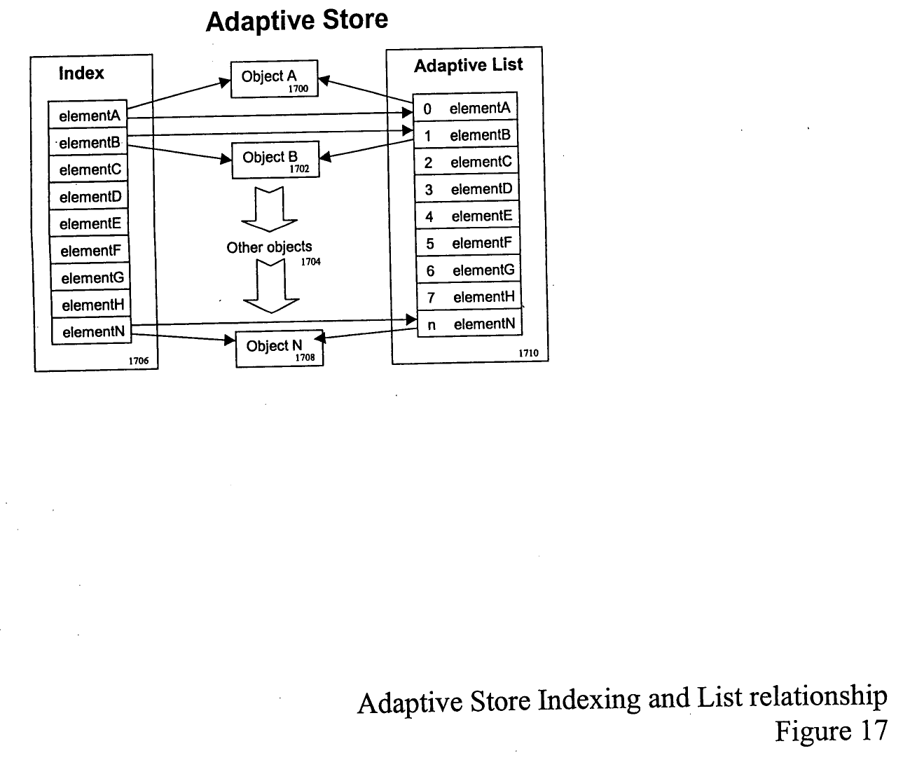

FIG. 17 illustrates an Adaptive Store including an Index 1706 and an adaptive List 1710 referencing data objects 1700, 1702, 1704 and 1708. The Index 1706 facilitates fast look accesses to specific elements without the need to traverse the Adaptive List 1710. Such indexing is useful when the exact nature of the data element being referenced is known. For example, hash tables are a fast index available for use with data items whose nature is exactly known, and allow objectN 1708 to be located without having to search through all the elements A through N in the List 1710.

If the exact nature of the data is not known or an associative match is required, the Adaptive List 1710 is searched using the Classification Comparisons as described earlier with reference to FIG. 12. Although hash tables can be sequentially accessed (allowing Classification Comparisons on each element), hash tables do not provide for access to stored data objects in a consistent or uniform manner. For example, searching all the elements in a hash table using conventional techniques may return the elements in the order CEDAHFGNB; whereas, the next time the hash table is searched the elements could be returned in a different order BACEFHNGD. As can be seen from previous examples, searching for a close match to an unknown data item or searching for an item when its exact location in the store is unknown is faster if the most frequently found data items are closer to the starting location of the search.

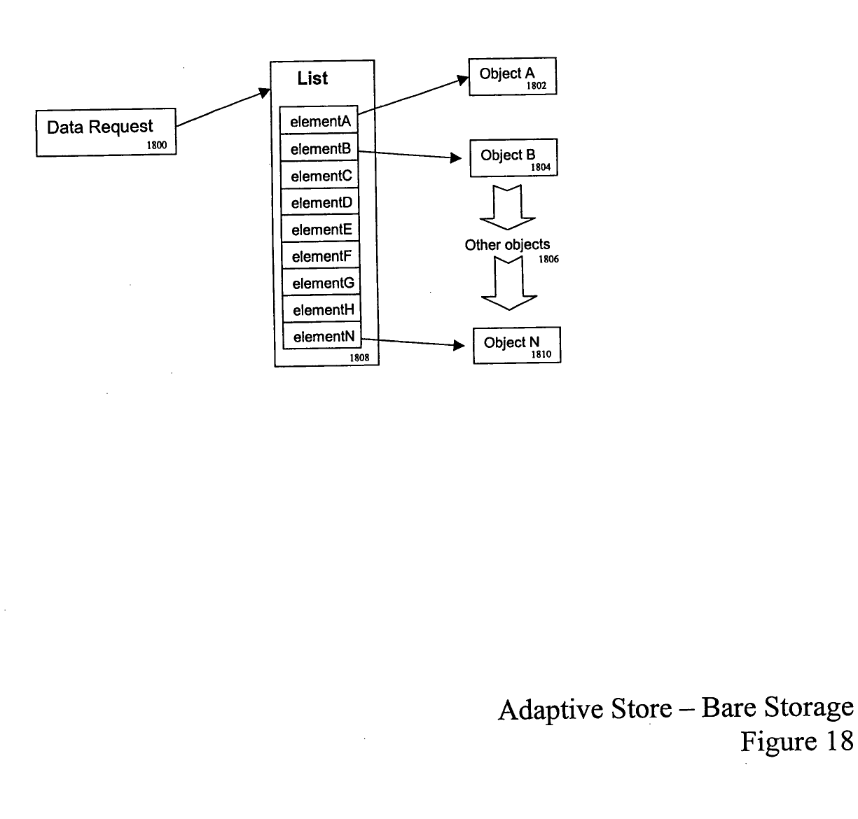

Although hash tables and other index devices are fast, they do not provide for arranging data items in a particular order. Indexes can typically increase the amount of storage space required for the data item and also increase the time taken for data items to be added, inserted and removed from the Adaptive Store. FIG. 18 illustrates an Adaptive Store without any indexing mechanism as may be particularly useful for embodiments having limited storage capacity.

With reference to FIG. 19, a list component of an adaptive store is shown in an initial state 1900. Notice is drawn to the position of the data items in the list—elements A through N corresponding to list locations 0 through n and with particular reference to list location 2 of the initial state 1900 containing elementC and list location 3 of the initial state 1900 containing elementD. The state of the list elements is shown in state 1902 after a first read access has been made to elementD in list location 3 of initial state 1900. Attention is drawn to the position of elementD which has been promoted in state 1902 one element up the list and elementC has been demoted in state 1902 one element. Subsequent accesses to elementD can be seen in states 1904 and 1906 to result in elementD being promoted one element toward the start of the list until elementD is the first element in the list 1906. Access to elementG in state 1908 shows the promotion of elementG towards the start of the list and access to elementH in state 1910 shows the promotion of elementH. In this way, the most frequently accessed elements are moved to the front of the list facilitating faster comparative searches.

The addition of a new elementZ at state 1912 results in the least used list member elementN being replaced by elementZ. The manipulation of the data elements in Adaptive Lists are not limited to being as specifically shown in this example. Other manipulations, such as deletion of elements in the list, insertion of elements into the list, and sorting are also employed in some embodiments.

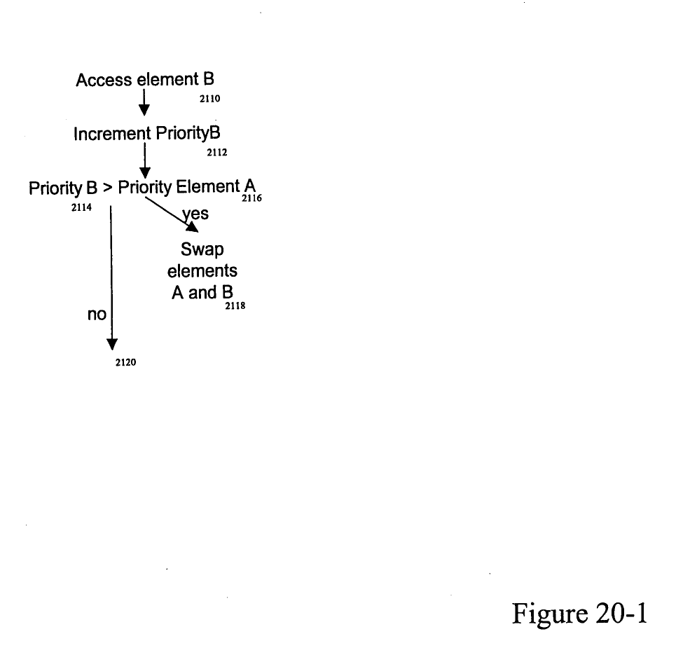

Furthermore, adaptive lists can assign priority values to specific elements or sets of elements as shown with reference to FIG. 20 and 21. Prioritizing a list element increases its probability of remaining in the list or reaching the top of the list. The use of priority values helps to ensure that prioritized elements remain in the list or, on the contrary, that an element will be quickly dropped from a list.

Item 2000 shows the initial state of an adaptive list prior to elementE being accessed. Item 2002 shows elementE's promotion, Item 2004 with elementE and elementC having the same priority value and finally elementE being promoted with a higher priority value than elementC. An example algorithm is shown in FIG. 20-1. Specific attention is drawn to the other priority values which are of varying values resulting from, for example, other elements being inserted and removed. Such elements may have been inserted from other adaptive stores in other systems on a network, for example. Weighted list values facilitate sharing Adaptive List data and alter the priority of the elements in a list across adaptive stores.

Another example of element prioritization is the adaptive migration of elements between adaptive stores interconnected on a network. Another example is the pre-loading of Word Identifier lists based on the priority of a headword (FIG. 10) in an adaptive list. The use of event triggers 1410 (FIG. 14) facilitates contextual interaction with singular or a plurality of other lists within the same embodiment or a plurality of interconnected embodiments. The example described is just one embodiment of a list prioritization, and the particular method of calculating and utilizing the weighting values differs among embodiments. For example, some embodiments may use a weighting value to sink elements to the bottom of the list rather than promoting them to the top. This “negative bias” produces lists containing the least frequently used elements. Negative bias lists are, for example, used by embodiments to eliminate least used elements from singular or a plurality of lists. The data remaining in these lists has by definition a higher relevancy than if the list still contained known little used elements. Embodiments using a combination of weighting and prioritized lists can significantly reduce the time taken to perform Word Comparisons (FIG. W7) as the amount of data requiring comparison is greatly reduced. It can be seen from FIG. 13 in particular that adaptive lists for probable classification 1332, 1334, 1336 and probable replies 1338, 1340, 1342 may be built using triggers associated with the addition, insertion, deletion, promotion and demotion on elements in Adaptive Lists.

Now, extraction of data is discussed. To extract data of interest from data sources, the client node uses a knowledge of the nature of the data to be extracted, where to extract the data from and how to extract the data. The location of data in data repositories is often subject to change, a particularly good example being the world wide web. To locate data of interest, it is useful to have knowledge of the initial location of the data, how to recognize that the data has moved and how to identify the new location. For example, data repositories on the world wide web typically employ a series of URL's in a chain that eventually locate a data item as shown in FIG. 21. URL 2100 is for an archive site with a page containing links to five files, file01, file02, file03, file04 and file 05 spanning URL's 2102, 2104, 2106, 2108, 2110, and 2112. Since these files are spread over a number of different URL locations and on different repositories, a mechanism is employed to filter out links to sites that are not of interest. This includes rating the links in a page as “of interest” and “of no interest”. Links “of no interest” are not followed. Links “of interest” are followed to a specified depth. By applying data locators to pages pointed to by links “of interest”, data is tracked or followed data across a plurality of sites. The depth parameter defines the number of links to be followed before data of interest is found as a result of matching data locators.

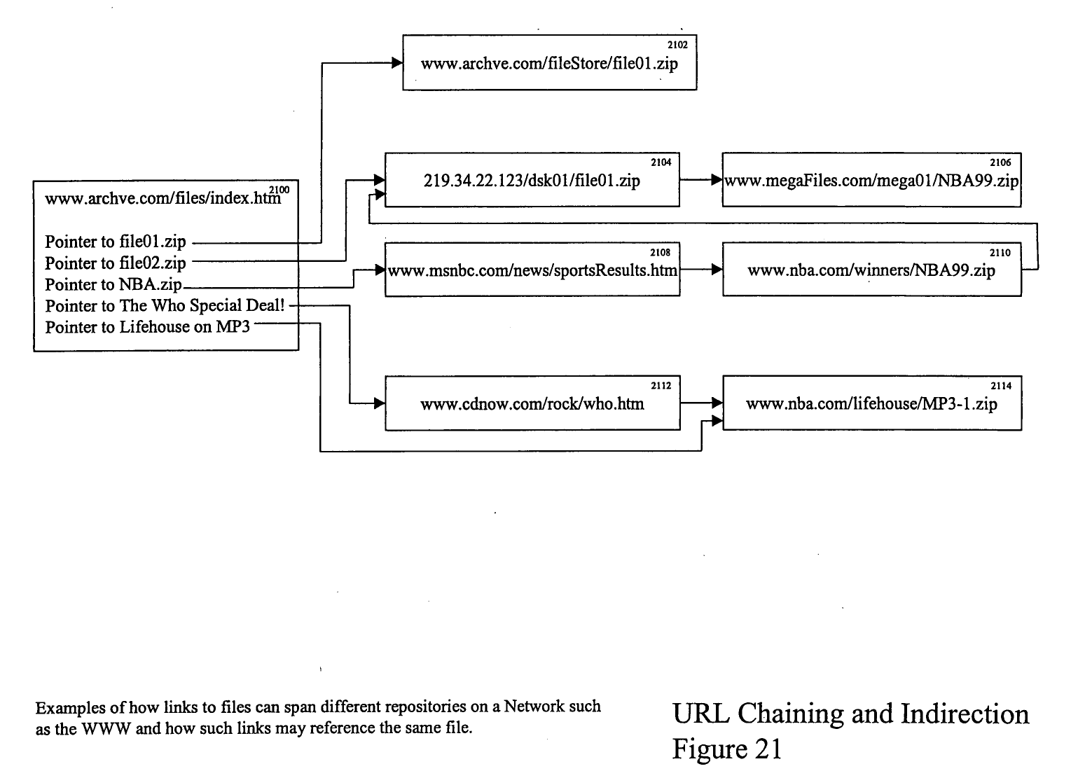

In one embodiment, the knowledge of the data discussed above is encapsulated into a Universal Data Locator (UDL) in the form of a series of parameters that, once combined, form a Universal Data Locator Object (UDIO). With reference to FIG. 22, the parameters for creating a UDIO 2210 originate from item 2200 that is an embodiment of a parameter source as described with reference to FIG. 5. In embodiments where the data location is known, or where the data is not subject to unpredictable changes in location, or when the nature of the changes are otherwise described by a parameter source, these parameters are sometimes combined with the data locators 2206 and the extraction method 2208 to form a UDIO 2210. The location of data in pages on the world wide web and the location of the page on the world wide web are both subject to unpredictable change requiring further steps in the construction of a UDIO 2210.

FIG. 7 illustrates operations for locating and tracking such changing data. A UPO 2300 describes a world wide web Uniform Resource Locator (URL) from which the page pointed to by the URL is downloaded 2306. Alternatively, if a URL is not provided, a UPO 2306 provides a WWW page source in a form expected by the data locator 2308. The data locator uses parameters provided by a UPO 2304 to determine the location of the data of interest on the page source provided by 2306 or 2302 and formats the location determination into a form usable by 2314. Keys identifying the data are generated at 2314 using parameters from UPO 2316. In the event that the data is split across several URL's or data links, the locations and definitions of such URL's and links are determined by 2312 using parameters from UPO 2310, 2324. The particular operation of 2306, 2308, 2312 and 2314 are typically dependent on the nature of the specific data of interest that varies among different embodiments. For example, an embodiment may use regular expressions that are a commonly used programming technique well known to those skilled in the art to identify data and the location of data. Embodiments may use a singular or a plurality of Adaptive Lists. Example location information may be the number of bytes from a particular known location UDI 2204 such as the start of the data source. Another example is a number of bytes contained between two identification keys 2314. Another alternative is a data search for strings or characters or an adaptive search or other data in pages until a match is found. Another example is an extraction method embodied in a software executable or source code compatible with and capable of being executed in a manner facilitating the correct extraction of the data of interest. In some embodiments, the user may control the nature of these searches from parameters from a UPO. In other embodiments, the contextual meanings are provided relevancy by the user to determine the contextual accuracy. Such relevancy may be provided from a GUI interface, speech recognition, email or other device. This relevancy forms part of the weighting where positive values indicate increasing relevance and negative values indicate decreasing relevance. Embodiments such as those employing Word Classification Differences would give relevancy to the difference between the contextual Word against the Word Classification code being compared.

Accuracy of a data item can be defined as the measure of difference between the data item and a single reference data item or plurality of data items. In a situation where data is being discovered during, for example, a search operation on repositories on the World Wide Web the reference item or items are being determined from the discovered data. Clearly, the more data being examined, the more accurate the references will become. In an example comparison, discovered data is first decomposed into a plurality of meaning definitions that are stored in association with the discovered data in an adaptive store. The priority value that the data object takes in the store (FIG. 20) is proportional to the comparison difference (FIG. 12) when the meaning is compared with other data. In this way, the adaptive store contains the most relevant data item at the start of the store (or is otherwise made more prominent). For example, an adaptive store termed “Reference Store” would contain discovered data in association with the meaning of the said discovered data that could then be used as a reference against which other data could be compared. The comparative difference between the compared data and the reference data could be used to influence the priority values (FIG. 20) in the store thus providing a hierarchy of contextually relevant reference data.

The data location 2204 or URL location 2202, data item selection criteria 2206 and extraction method 2208 are combined into a Universal Data Identifier Object 2210 that may be stored in a “persistent object store” or on media or in another storage mechanism in a compressed or uncompressed form. Persistent object stores are used for temporary or permanent storage of data, computer executable programs and computer source code the repository of which can reside independently or on any node in a network.

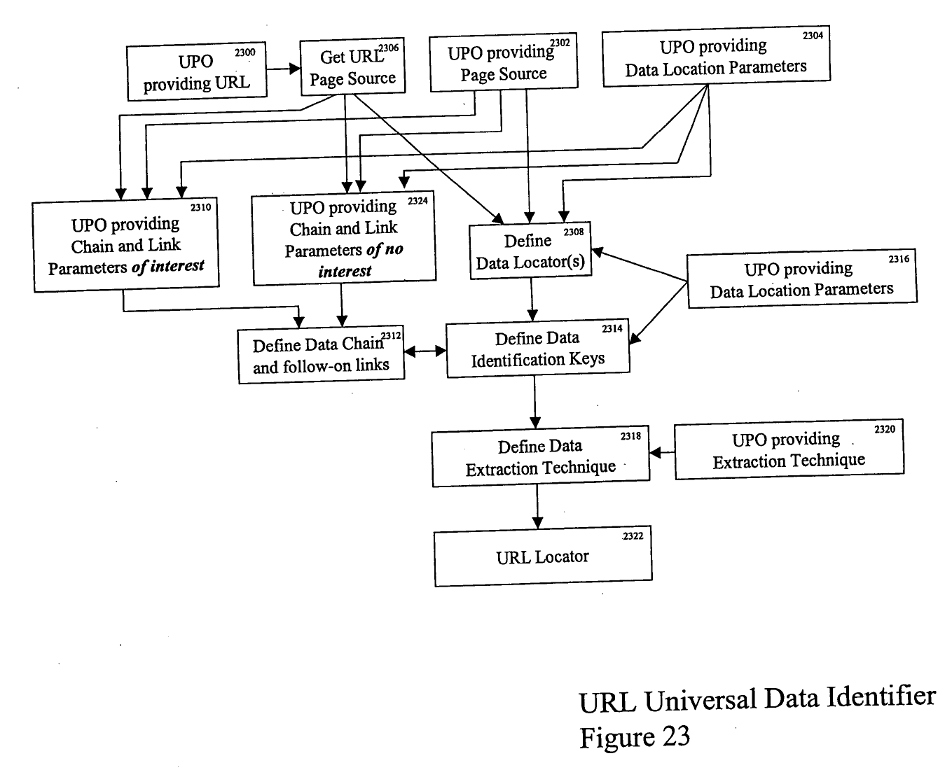

Referring to FIG. 24, a UDIO 2400 provides a description of data to be extracted to an extraction engine 2402 that uses the data descriptor information in the UDIO 2400 to locate and extract the described data into a persistent storage repository taking supplemental parameters from UPO 2410. Data normalization 2404 is performed using parameters in the UDIO 2400 and those in UPO 2406 to convert the extracted data into a context expected by the Analysis Engine 2408. Using parameters from UPO 2410, the analysis engine 2408 takes normalized data from 2404 and performs such operations, comparisons and operations as specified in UDIO 2400 and UPO 2410. Analysis output from 2408 may be stored in a repository before being directed to the results processor 2412. The extraction engine 2402 operates on the parameters contained in the UDIO 2400. For example, an entire site may be downloaded by setting the UDIO parameters to a URL and setting parameters to download every page indicated by every URL reference in the page. In another example, all pages containing text contextually matching those Word Classifications in an Adaptive store may be downloaded from a plurality of sites.

It is common practice for URL references in a world wide web page to point to other world wide web sites, which could result in all the pages in the entire world wide web being downloaded. To avoid, for example, downloading (or attempting to download) the entire world wide web, some embodiments include exclusion parameters in the UDIO and UPO-2406, 2410 to control which URL's the extraction engine 2402 may follow. Such exclusion parameters may exclude a plurality of domains, node and data repository locations, and specify a maximum depth into a repository that the extraction engine 2402 will follow data types pointed to by a URL. In other embodiments, the exclusion parameters and URL traversals are performed in other parts of the system such as data normalization 2408. Examples of these exclusion parameters allow an embodiment to extract all the email addresses from specified repositories. Another example embodiment uses these exclusion parameters to only download files of a particular type such as music or pictures. Another example embodiment uses the extraction parameters to follow price information across many repositories. Another example embodiment uses a mixture of extraction and exclusion parameters in Adaptive Lists to find contextually similar phrases and text in a plurality of sites where each site is traversed in accordance with the results of Word Classification Comparisons between text discovered in the sites and that supplied by a user or from a UPO.

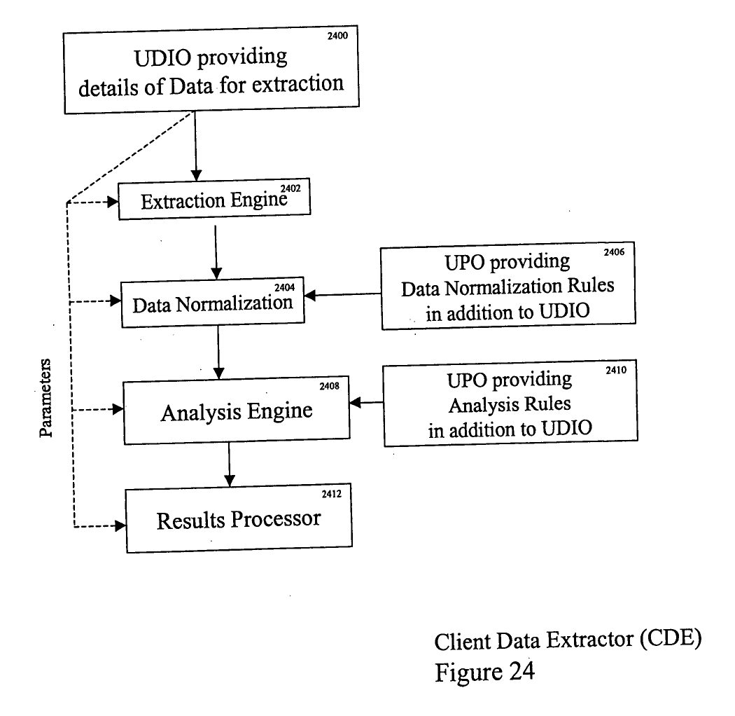

The extraction engine is shown in more detail with reference to FIG. 25. A UDIO 2500 describes parameters of data locations to be extracted that form the initial entries 2502 in list 2504. The data to be extracted is extracted from the data repository with the extraction engine 2506 before being stored in a persistent store 2510 and forming the input to the URL list manager 2508. The data in the persistent storage 2510 is normalized 2514 to convert it into a context which can be more easily used by other elements, such as the analysis engine 2408. In some embodiments, such normalization employs Word Classifications in Adaptive Stores to reconstruct contextually compatible formats that are usable by other elements such as the analysis engine 2408. This normalization addresses the problems of inconsistent and incompatible words, phrases and other data in the persistent store 2510.

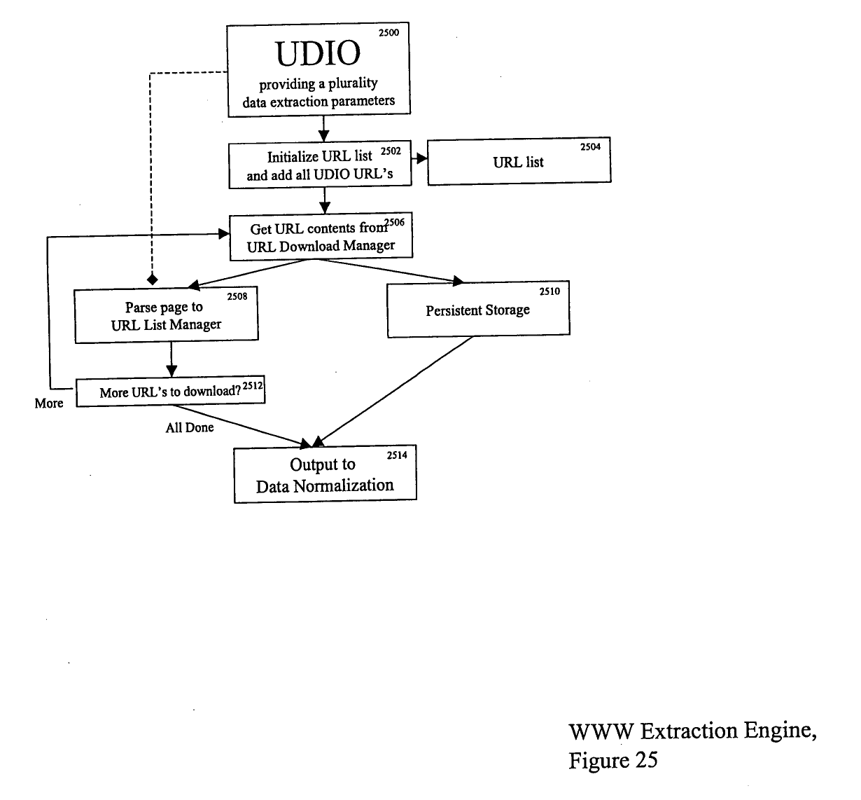

With reference to FIG. 26, URL's describing data to download are removed from the URL list 2604 in accordance with parameters supplied by UPO 2600 and the UDIO 2606. Example parameters 2614 determine the way in which data is extracted from the URL. Using the world wide web as an example, world wide web servers typically maintain information on the number of times the server has been accessed, each access being referred to as a hit and information pertaining to each hit is typically recorded by the world wide web server for later analysis to determine, for example, the origin of the hit and what area of the world wide web server was accessed by the hit. World wide web servers have limits on the number of hits for which they can concurrently supply data and embodiments of this invention could easily exceed the number of hits that a world wide web server could support. Additionally, world wide web servers typically record the type of browser that was used to access the data on the server. In accordance with some embodiments, there is control over the way that the hits appear on the world wide web server and/or to appear as a particular type of browser, and/or to appear as a human operator access, a practice known in the art as spoofing.

The combination of time interval, page sequence and browser type information that the world wide web server records about the access is termed a hit signature. Element 2614 show various parameters 2614-4, 2614-5, 2614-6, 2614-7, 2614-8 and 2614-9 controlling the periodicity of hits on the world wide web server. Analysis of hits and hit signatures on a world wide web server can provide information about the origin of the hit. For example, parameters 2614-1, 2614-2, 2614-3 define the order of the URL's accessed on the world wide web server and these, in combination with 2614-4, 2614-5, 2614-6, 2614-7, 2614-8, 2614-9 can make accurate analysis of world wide web hit signatures almost impossible. This is especially useful to detect spoofing accesses. For example, a human's speed of access to URL's is limited by the speed in which the browser being used can display the page. The display speed of a page can often span several (often tens of) seconds if the server being accessed is using the widespread and popular practice of displaying banner advertisements before displaying the rest of the page. Thus any access faster than, for example, 500 ms could be considered to be from an automated mechanism. Furthermore, concurrent or parallel access to the server is limited by the speed of the computer hardware, network and the ability of a human to select URL's on a web page within the previously discussed 500 ms. Thus, there is a relatively high level of probability that hits with a frequency greater than 100 ms are from an automated mechanism, as it is virtually impossible for a human to access links faster than this due to being limited by browser refresh speed and the human ability to visually and physically respond to displayed information. However, it is difficult to determine that a slow hit frequency is from an automated mechanism and not from a human, without some other indicia (e.g., the mechanism accesses the robot.txt file which servers often provide as a control mechanism when the server is indexed by a WWW search engine). The robot.txt file is not normally accessed from a human using a web browser, but such access could spoof the server into considering that the human access is in fact an automated mechanism.

The determination of which URL to download is performed at 2602 using the parameters 2614 from the UPO 2600 and UDIO 2606 as previously described. In one embodiment, removal of URL's is arbitrated from the start and end of the list, waiting for a random period of time between each removal. In other embodiments, elements are sequentially removed from the start of the list with no time interval delay. Combining time intervals with random selection of URL's can emulate the way in which a human would access information on a web site whereas a fast sequential access would enable analysis of world wide web server hits to determine that a machine is making the hits.

In some embodiments, use is made of both time interval and random URL selections, as described in element 2514. Emulating or spoofing human access behavior is further enhanced by using measured values for at least some of the parameters 2614. Such parameters can be obtained by using a browser to measure tmin, tmax and tav access times for specific pages on the web site to be accessed on a range of internet connections providing for representative internet access speeds. Internet access speeds and latencies typically vary between periods of the day and the days in the year. In accordance with some embodiments, parameter values for 1014 are taken from averages over period of time and under different conditions.

Once identified, the URL is removed from the URL list 2604, by 2608 and parsed to a download thread 1010. Use may be made of thread pools 2612 which are known in the art. The URL data download is performed by 2616 and converted into a form usable by 2510 and 2508. The persistent store 2508 records accessed URL's which are POO.

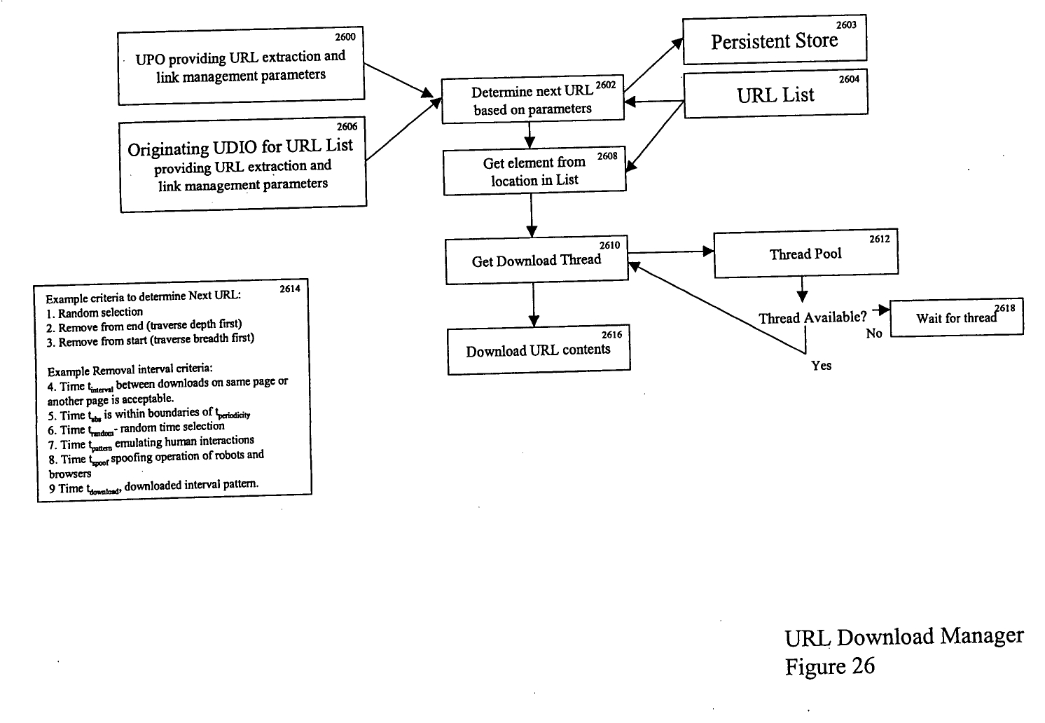

Turning now to FIG. 27, the URL list manager 2708 components are described. The downloaded URL 2708 and 2506 is analyzed 2702 for the presence of any further URL's, and are extracted into a temporary list 2704. Each element in list 2704 is validated against parameters from UPO 2706 and UDIO 2710, and valid URL's are added to the URL list 2704 by 2712 in accordance with parameters from UPO 2706 and UDIO 2710. For example, URL's that are outside the scope of a plurality of repositories on a network may be rejected. Alternatively URL's that do not contain a certain plurality of data or data sets may be rejected.

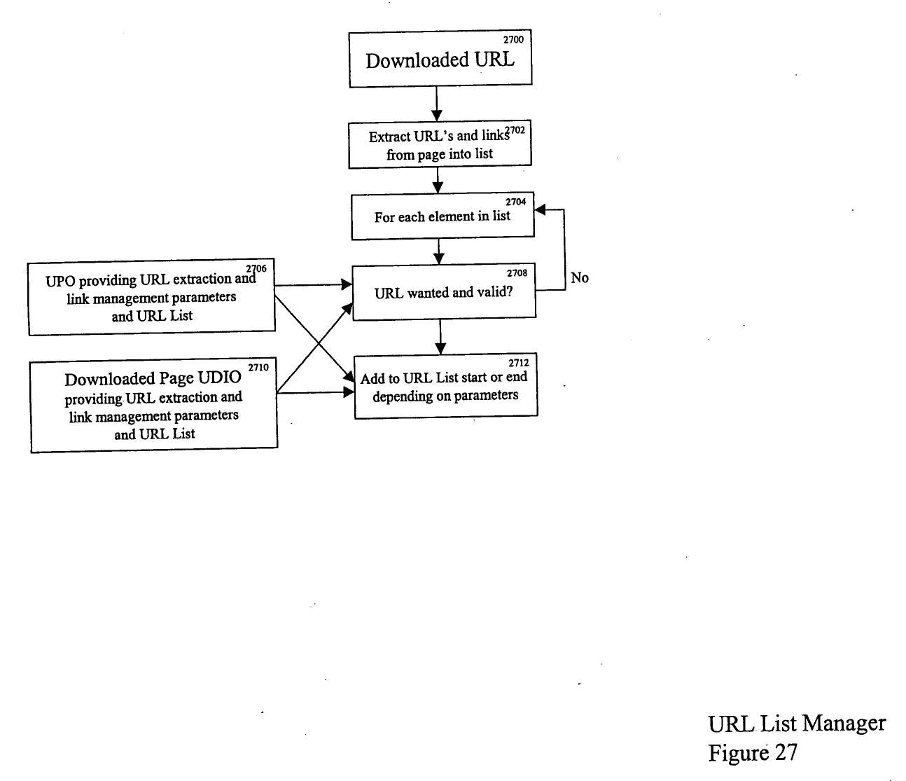

With reference again to FIG. 24, extracted data is analyzed by Analysis Engine 2408 using parameters in UPO 2410 and UDIO 2400 before being parsed to the results processor shown in FIG. 28. Referring now to FIG. 28, the type of formatted output is selected by switch 2804 using parameters from UPO 2802 using data from 2800. Example formatted types are shown as 2806, 2808, 2810, 2812, 2814, 2818, 2820, 2822, 2824. Embodiments of the invention utilize other formatted outputs in addition to or instead of those shown. The functionality of each of the formatted types may vary from embodiment to embodiment and may also vary according to the nature of the data 2800 being formatted. Examples shown provide for the results to be stored 2808, converted into the HTML 2810 markup language that are displayable by a web browser, email 2812 the results to a plurality of destinations, fax 2818 the results to a plurality of destinations, store the results in a data base management system 2820, store the results as data in a file 2822, and encode 2824 the data.

In accordance with some embodiments, a plurality of contextually similar data 2816, 2800 are subject to a comparison 2806. The nature of the comparisons may vary according to the nature of the data being compared and the required formatted output. Comparator 2806, results formatters 2806, 2808, 2810, 2812, 2814, 2818, 2820, 2822, 2824 and compression 2826 use parameters from UPO 2802. The formatted results are presented for output and storage 2828. Using the initial rose example, some embodiments may use the comparator 1206 to compare extracted data from a plurality of rose suppliers and sources and generate a report comparing the prices and varieties found.

Although the above examples have emphasized the applicability of the data extraction method to use with the world wide web, the techniques described may be usable with any data source, such as a flat file containing data, with or without data chaining information such as URL's and/or other hyperlinks.

The present invention may be provided as one or more computer-readable programs embodied on or in one or more articles of physical manufacture and one or more articles capable of light, electromagnetic, electronic, mechanical or chemical or other known distribution. The article of manufacture may be an object or transferable unit capable of being distributed, installed or transferred across a computer network such as the Internet, floppy disk, a hard disk, a CD ROM a flash memory card, a PROM, a RAM, a ROM, a magnetic tape or other computer readable media. In general, the computer-readable programs may be implemented in any programming language, although the Java language is used in some embodiments, and it is useful if the programming language has the ability to use Regular Expressions (REGEX). The software programs may be stored on or in one or more articles of manufacture as object code.

Some examples of how the described embodiments operate are now discussed. The first example illustrates a “page hierarchy extraction”. Namely, the increasing use of Active Server Pages and other mechanisms that dynamically generate world wide web page content interfere with the generation of a hierarchy or tree of pages to be generated. Such a hierarchical tree representation is extremely useful when performing server administrative tasks. In addition, such a representation allows the world wide web designers to understand the data and structural layout. Using the described method, such a representation may be produced in configuring the internal components in a manner described herein.

The UPO 520 (FIG. 5) is configured to include the URL of the start (home page) of the world wide web site to be extracted. Since the page components are not being analyzed, it is not necessary to configure any parameters for the NLP (FIG. 6).

Parameters for the UDIO 2210 (FIG. 22) are configured in a UPO 2200. The data location 2204, data item locators 2206 and extraction method 2208 are not required since it is desired to extract the entire page. The URL locator 2322 is set to accept any URL contained within the WWW site and to reject any URL outside the boundaries of the WWW site, data locators 2308 set to identify any URL which would be extracted 2318 by using the identifier ‘<a href=’ and ‘</a>’ as start and end delimiters. The extraction engine 2402 extracts the data from URL's and the data is normalized 2404 by using parameters 2406 to discard the page contents and keeping the page title forming the title and URL into tabular data in a form expected by results processor 2412. Encountered URL's of interest are added to the list of URL's to extract 2410.

The analysis engine 2408 is configured by UPO 2410 to take no action and the page title, URL, URL parent and URL siblings (from 2506 and 2510) are parsed to the results processor 2412 as tabular data. UPO 2802 is configured with parameters to take analyzed data 2800 (from 2408) for storage 2808 in a tree representation and to email 2814 the extracted URL and title to a plurality of locations. The process by which an entire world wide web site is traversed can be extended to other applications such as the comparison of two sites.

The second example is site extraction. This is similar to the first example in that all URL's of interest are traversed and those URL's that are of no interest are ignored. The UPO 520 (FIG. 5) is configured to include the URL of the start (home page) of the two world wide web sites to be extracted. Since the page components are not being analyzed, there is no need to configure any parameters for the NLP (FIG. 6). Parameters for the UDIO 2210 (FIG. 22) are configured in a UPO 2200. The data location 2204, data identification keys 2314 and data extraction technique 2318 are configured (FIGS. 3 and 4) using UPO 2216 and UPO 2220 to extract data of interest from each extracted URL of interest. The URL locator 2322 is set to accept any URL contained within the world wide web site and to reject any URL outside the boundaries of the world wide web site. The extraction engine 2402 extracts the data from URL's and the data is normalized 2404 by using parameters 2406 and 2410, into tabular data including the URL or the page, into a form expected by results processor 2412 and comparator 2806.

Encountered URL's of interest are added to the list of URL's to extract. The process by which an entire world wide web is traversed only following links of interest can be extended to embodiments that include the addition of more sites. Furthermore, the client data extractor (CDE, FIG. 24) can be extended to extract data from other sources that can be used by the results processor (FIG. 28).

Attention is now turned to the aspect of the invention relating to analysis of access to an information server. The origin of an access to an information server (referred to as a hit) is difficult to determine without resorting to visual or human contact. Hits can originate from a human using a client executing a WWW Browser and also from mechanized devices and computer programs (robots). As used herein, the term “information server” includes any device or machine capable of accepting data requests and supplying information to satisfy the request.

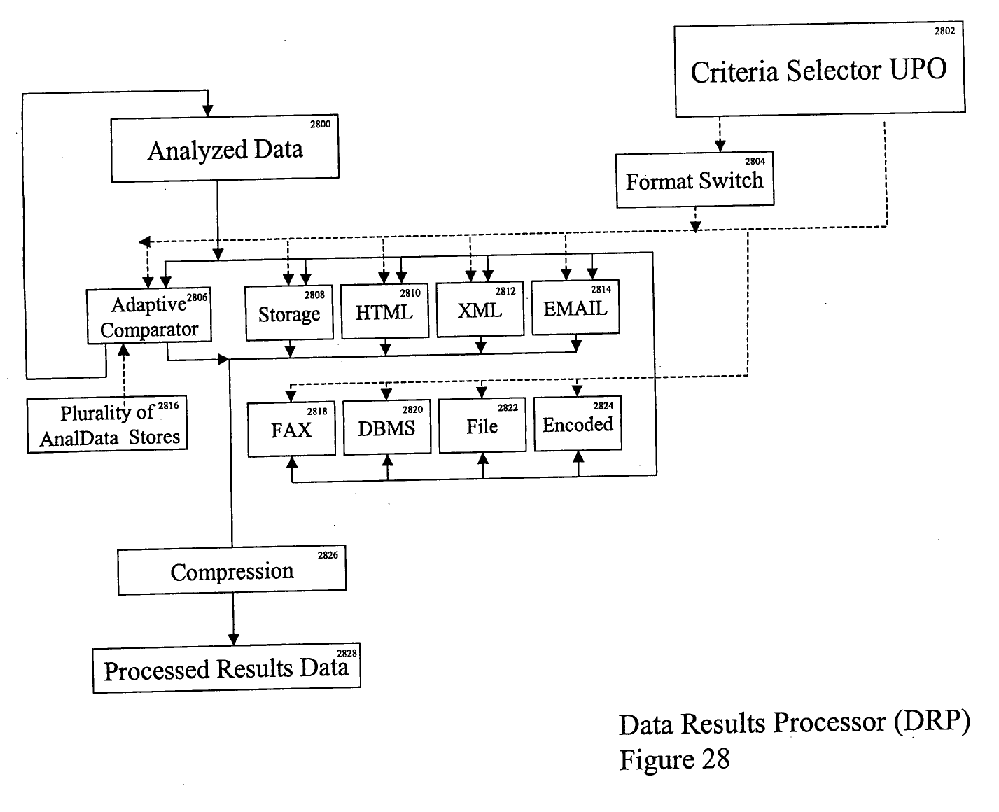

FIG. 29 illustrates a network of information servers and information assessors, such as may exist on the internet. With reference to FIG. 29, client nodes 2900 and extraction robots 2908 are coupled to a plurality of information servers 2902 by a common network 2901. The servers 2902 employ a mechanism to identify and differentiate the hit origins so that they may take appropriate action when a client node 2900 makes an access and different actions when the extraction robot 2908 makes the access. Client nodes 2900 may be in the form of humans and/or other non-automated devices using a browser, software applications that access data on the server and other mechanized agents to which the server wishes to provide data. Such users are referred to as a friendly access or friendly hit. Extraction robots 2908 may be in the form of spiders, robots, crawlers and other software or mechanized agents that require little or no human intervention in operation.

Such extraction robots 2908 devices are often used for competitive analysis or for “stealing” copyrighted material, and are devices to which the server 2902 may wish to block access. Such accesses are referred to as an unfriendly access or unfriendly hit. Each hit (or collection of hits) has a signature that provides information that can be used to identify friendly and unfriendly accesses to the server. Determining the absolute origin of a hit would require physically tracing the network connection from the server to the origin. Physically tracing the network connection is virtually impossible in practical terms since the duration of the hit may be shorter than a second. It is possible to determine a probability of the origin of the hit from analysis of the hit signature against known properties of the server, known typical properties of clients using browsers 2900 and extraction robots 2908.

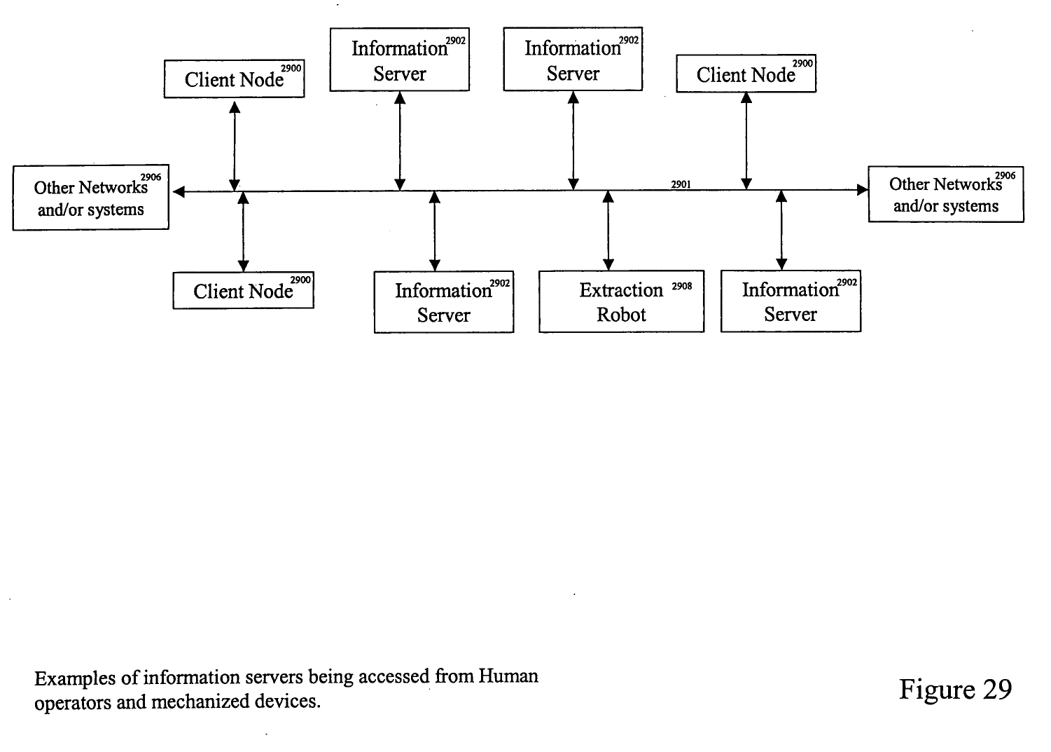

FIG. 30 shows timing properties 3002 to load a page into a display device such as a world wide web browser; properties of human access to a world wide web page 3004; and properties of non-human access to a world wide web page 3006. With reference to 3002, although variations exist between commonly used and other embodiments of browsers and other mechanisms used to display a world wide web page, the basic timings are split into the activities required to load the textual part of the page text, the activities required to process other components in the page such as scripts t_other the total minimum time to load the page being t_min. With reference to 3004, the activities that a human operator takes to react to and access a URL are the time to respond to a displayed page and access a URL t_response, the activities required for the apparatus (e.g., Browser) to process the URL access t_internal, other miscellaneous times t_other, the total minimum time to load the page being t_min.

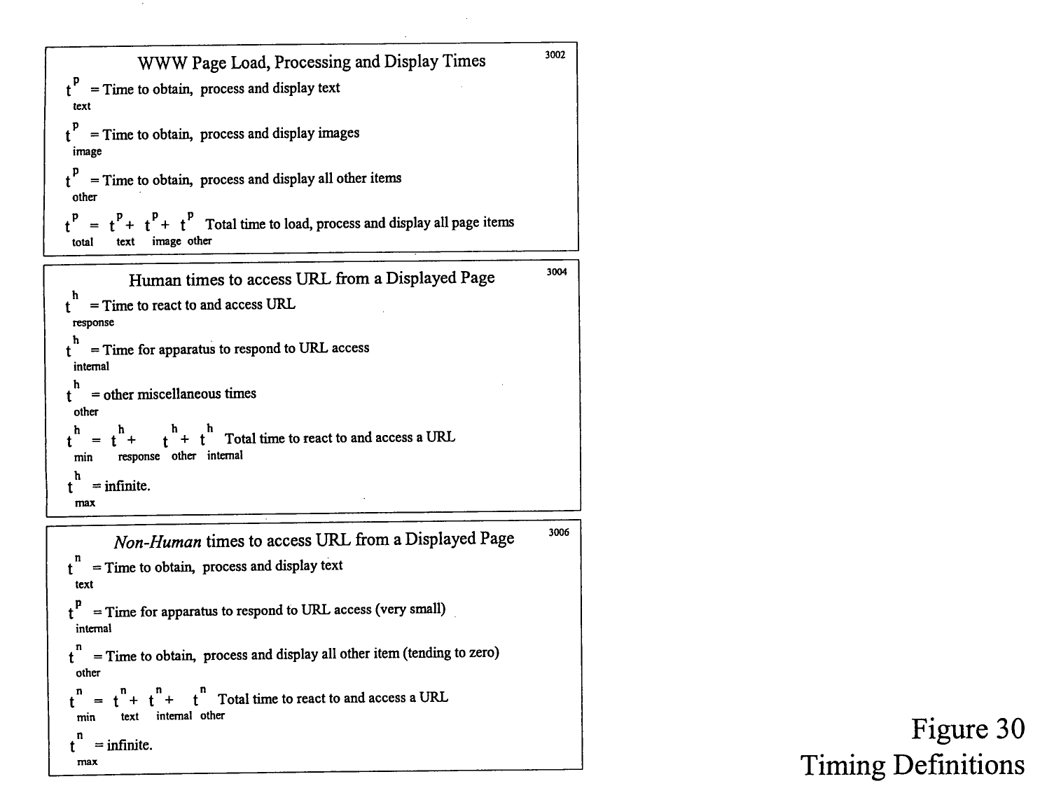

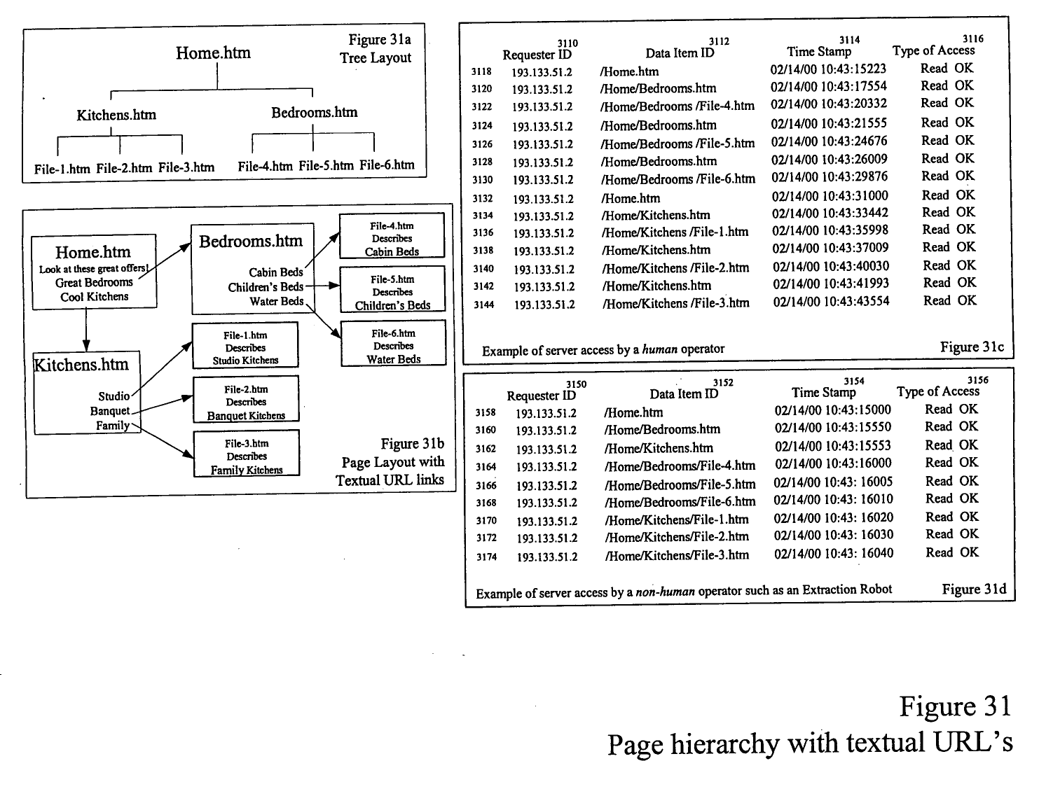

The corresponding value for t_max can be infinite. Human reactions are statistically longer than that of a mechanical device. Additionally, visual access to URL's can require the entire world wide web page to be loaded as URL's forming part of an image map (FIG. 32 discussed later) cannot be accurately accessed until the image appears on the screen. The now common practice of displaying advertisements prior to displaying the rest of the page further increases the response time. Image maps typically require the user to position a pointing device over areas of the image onto which URL's have been mapped. Furthermore, the way in which humans typically interact with a browser usually results in pages being re-loaded. For example, with reference to FIG. 31b, the page home.htm has to be loaded to enable the page “bedrooms.htm” to be selected. The page “kitchens.htm” cannot be selected until the page “home.htm” is re-loaded as the page bedrooms.htm is being displayed. These times are included in t_other.

Turning again to FIG. 3 with reference to 3006, the activities of a non-human mechanism to react to and access a URL is dependent in part on the speed with which the textual component of the world wide web page is available to the mechanism. This is because the mechanism can see URL's contained in the page, whereas a human operator has to wait until the web page displaying device (a browser) has displayed the page complete with all the images that may contain URL maps. Although there are other timing components, they are relatively small. The activities to obtain the textual part of the page t_text, the time for the apparatus to respond to a URL access t_internal, the time to process all other items t_other resulting in a minimum time to access a URL from a page t_min. The corresponding value for t_max can be infinite. Non-human access to a URL is very much faster as only the textual part of the page containing the URL's is required.

FIG. 31a to 31d shows an example of a simple web page hierarchy containing simple URL's embedded in the textual part of the page. It is possible for URL's to occur in other parts of the page such as image maps (as shown in FIG. 32). Referring to FIG. 31a to 31d, the page layout relationships depicted in the commonly used tree representation are shown. FIG. 31b shows the page relationship as a simplified visual representation. FIG. 31c shows an example of the information typically recorded by information servers.

The “Requester ID” 3110 identifies the device requesting information, in this case an Internet IP address. The ‘Data Item ID’ 3112 is an identifier uniquely locating the data item being accessed in the information server. The ‘Time Stamp’ 3114 is the time of the request using the time local to the information server. The ‘Type Of Access’ 3116 in this instance contains supplemental information.

The access times shown are typical minimums and represent the entire time to load and respond to the required URL. The sequences 3118-3144 are a hit signature for the data items accessed. Each hit 3118-3144 represents an individual access to the server and from these we can define the terms th_av and th_max and th_min can be defined, which describe the average access time between hits, the minimum access time (i.e., fastest access) and maximum access time (i.e., slowest). These terms form the time component of the hit signature. The other component of the hit signature is the order in which the pages were accessed.

From FIG. 31c, it can be seen that each page access required the parent page to be loaded. Furthermore, once 3136 was loaded, the parent 3138 had to be loaded before the next page 3140 could be accessed. This part of the hit signature employs knowledge of the tree relationship as shown in FIG. 31a. Such relationships are not always known, especially if the information server is dynamically generating page content or is an ASP server. However, it has been shown how such a relationship can be derived by referring to Example 1.

Reference to FIG. 31d shows how the same pages may be accessed from an extraction robot that is making no attempt to disguise its activity. The sequences 3158-3174 are a hit signature for the data items accessed. Each hit 3158-3174 represents an individual access to the server, and from the hits the terms tm_av and tm_max and tm_min can be determined. Tm_av, tm_max and tm_min describe the average access time between hits, the minimum access time (i.e., fastest access) and maximum access time (i.e., slowest) respectively. These terms form the time component of the hit signature.

Another component of the hit signature is the order in which the pages were accessed. From FIG. 31d, it can be see that the pages 3164, 3166, 3168, 3170, 3172 and 3174 were loaded almost concurrently and without further reference to the parent page. This part of the hit signature employs knowledge of the tree relationship as shown in FIG. 31a. Such relationships are not always known, especially if the information server is dynamically generating page content or is an ASP server. However, it can be seen how this relationship can be determined, again with reference to the page hierarchy example.

Referring to FIG. 32a and 32b, a page hierarchy is shown in FIG. 32a and the visual representation showing the URL's embedded within an image map, represented by birds in this example, is shown in FIG. 32b. The hit signature component calculations are similar to those described with reference to FIG. 31c and FIG. 31d with the exception that slightly longer access times than those shown in FIG. 31c are expected. The effect of image maps is depicted in FIG. 32.

Pages that employ frames typically do not allow the user to use browser bookmarks or other shortcuts to go directly to a page. For a browser user to go directly to the file BirdsOfPrey.htm without having first loaded the page home.htm. FIG. 32 shows a series of pages employing the popular image map method of URL access. That is, with the image map access method, the user positions a pointing or other control device over the portion of the page depicting the information required, (e.g., represented by birds) and ‘select’ the URL in a way consistent with the apparatus used to display the page and image. Although the user could potentially try to remember the location of the URL on the page and position the pointing or control device accordingly before the image is displayed, there is no guarantee that the image will appear in exactly the same location on the page. Thus, human users typically wait until the entire image has been loaded, which could mean waiting for the entire page to load.

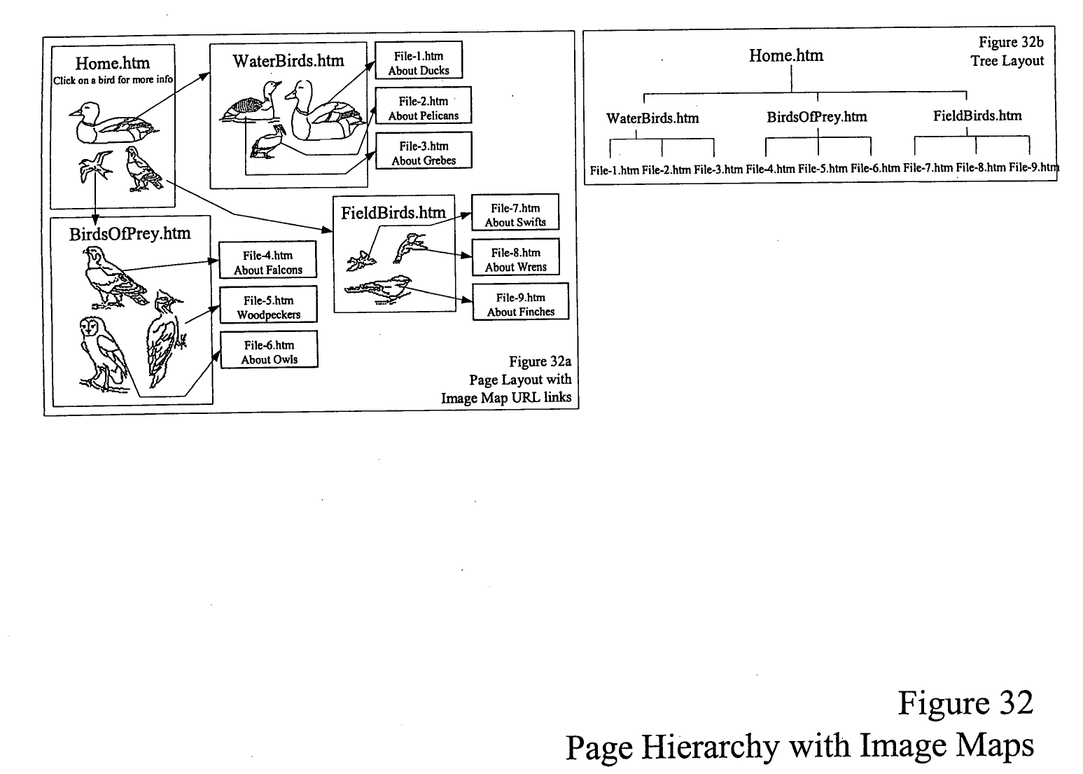

Reference to FIG. 33a to 33c shows methods employed to analyze hit signatures from FIGS. 31c and 31d with reference to the definitions set forth in 3002, 3004 and 3006 (FIG. 30). These methods calculate a probability that the origin of a hit is either human or non-human in origin by comparing actual hits with theoretical values and values determined by empirical means. These methods can calculate the hit origin probability of a hit after the accesses have occurred, but this is generally less useful than determining the hit origin probability substantially as the hits are occurring, thereby allowing appropriate responsive action to be taken in a timely fashion.

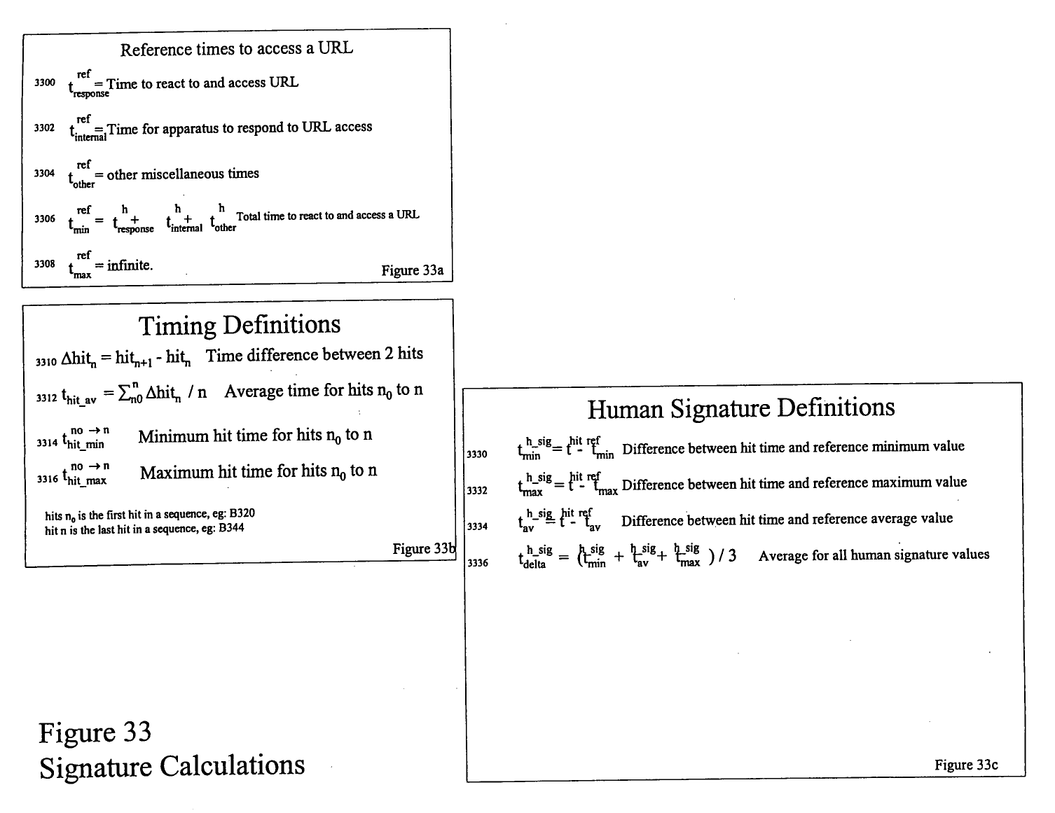

The determination includes initially generating the reference hit signatures for both human and non-human access. Human access reference hit signatures are calculated in one embodiment by repeatedly accessing the server with a browser from human control, under varying conditions and determining the average value for t_min, t_av and t_max. Non-human access reference signatures are calculated in one embodiment by repeatedly accessing the server with a mechanized extraction robot such as that described in the page hierarchy extraction example under varying conditions and taking the average value for t_min, t_av and t_max. Determining the signature for a human access is more reliable than for mechanized devices that are attempting to spoof or otherwise emulate human behavior. The human access signature is determined from the values of t_min , t_av and t_max in relation to their corresponding reference values and also the numerical distance between these values and their corresponding reference values for non-human access. These calculations are shown in FIG. 33b and provide values that are usable in conjunction with other parameters to provide an overall probability of the origin of a hit as shown in FIGS. 34a and 34b.

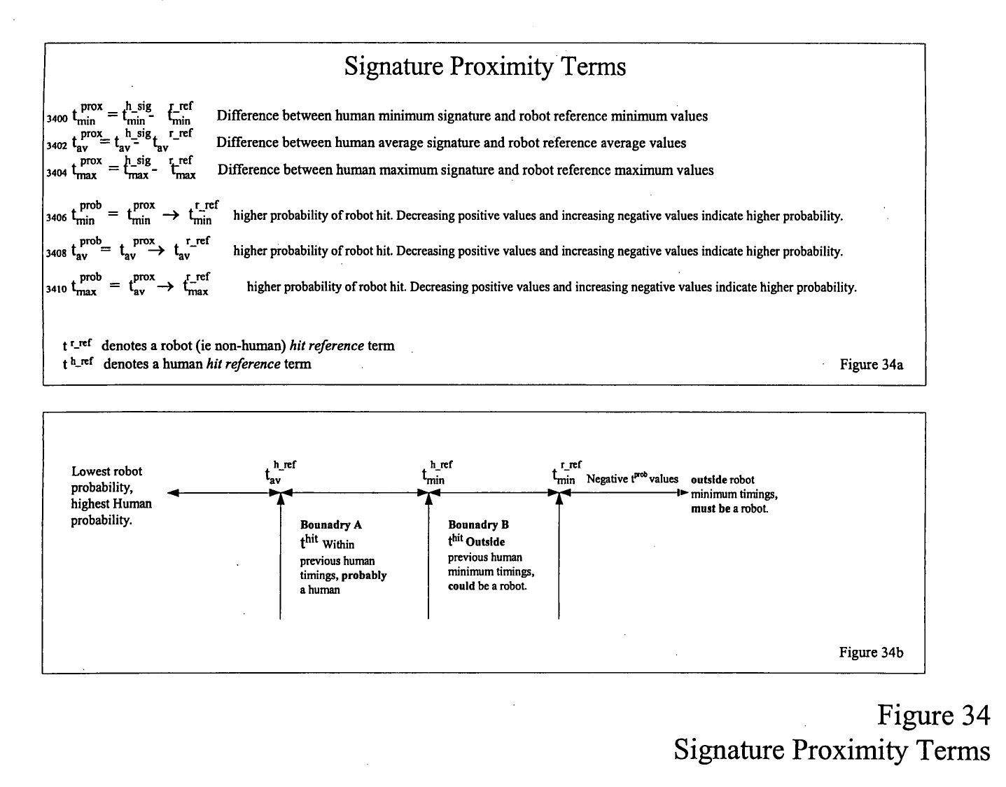

Another weighting value may be added, where the weighting value is based on the parent of the data item accessed. With reference to FIGS. 31c and 31d, it can be seen that human access to a data item almost always has to travel back to the parent page 3134 before other pages 3136, 3140, 3144 referenced by the parent maybe accessed. Data items accessed by a robot, on the other hand, frequently avoid this unnecessary access as can be seen in 3164, 3166, 3168, 3170, 3172 and 3174 unless the robot is deliberately attempting to spoof the server or emulate particular behavior (such as human behavior). Determining if the parent page has been traversed prior to another page reference by the parent is accessed employs a tree hierarchy that is quickly accessible, as shown in FIG. 35. The meaning of the probability values derived from FIGS. 33 and FIGS. 34 typically varies according to and between specific contexts of embodiments of the invention.

Referring now to FIG. 33a, reference terms that apply to both a human and non-human access are shown. Term 3310 defines the time to react to and access a URL from a page. Term 3312 defines the time for an apparatus to respond to a URL access. Term 3314 defines the total time for all other activities. Term 3316 defines the minimum access time for the URL access. Term 3318 defines the maximum access time, which in practical terms can be considered infinite.

Human access is typically longer than for non-human access for term 3310. Terms 3312 and 3314 are almost the same for human and non-human access and tend to be small under normal circumstances. In accordance with some embodiments, terms 3310, 3312, 3314 and 3316 are measured with reference to sample browsers and the servers being used under varying conditions of usage.

Reference to FIG. 33b shows a forward difference term 3320 that is the difference between two hits, n and n+1 (i.e., 3320 and 3322). Term 3322 describes an average difference for a range of hits n0 to n. Term 3324 describes the minimum for a range of hits n0 to n. Term 3326 describes the maximum for a range of hits n0 to n. The terms in FIG. 33b are used to define reference terms for human and non-human access. Reference to FIG. 33c shows the terms used to describe a human hit signature. Term 3330 describes the minimum signature value that is the difference between a hit and the human reference minimum 3316.

Term 3332 describes the maximum signature value that is the difference between a hit and the human reference maximum 3318. Term 3334 describes the average signature value that is the difference between a hit and the human reference average 3316. Term 3322 could be substituted for term 3316, providing a rolling average. Terms 3330 could also use term 3324 to include the average minimum time. Term 3332 could also use term 3336 to include the average maximum time. Term 3336 defines the average of terms 3330, 3332 and 3334 providing a dampening factor. The usage of these terms influences the accuracy of the calculations between specific embodiments and under specific load conditions, for which it is difficult to generalize.

FIG. 34a shows how the terms are combine to form a probability value that the specific embodiments can use to determine if a hit is human or non-human in origin. Some embodiments use this value as input to a graphical user interface or other display device to indicate that nature of the hit. Some embodiments also provide the facility to take appropriate action for the hit. Such action might, for example, be to disallow hits that have a very high probability of being non-human in origin.

FIG. 34a describes proximity terms that indicate how close a hit is to human and non-human references. Term 3400 defines the difference between the minimum human signature value and the robot minimum signature. Term 3402 defines the difference between the average human signature value and the robot average signature. Term 3404 defines the difference between the minimum human signature value and the robot minimum signature. The terms 3400, 3402 and 3404 may be positive or negative and are used to determine the probability terms 3406, 3408 and 3410. Decreasing positive values or increasing negative values indicate higher probabilities. Term 3406 defines the probability that the minimum signature is of non-human origin by calculating the distance to the robot minimum reference value derived from 3314 (FIG. 33). The closer 3406 is to term 3314, the higher the probability. Term 3408 defines the probability that the average signature is of non-human origin by calculating the distance to the robot average reference value derived from 3312 (FIG. 33). The closer 3408 is to term 3312 (FIG. 33), the higher the probability. Term 3410 defines the probability that the maximum signature is of non-human origin by calculating the distance to the robot maximum reference value derived from 3316 (FIG. 33). The closer 3410 is to term 3316 (FIG. 33), the higher the probability.

FIG. 34b shows how these probability values may be interpreted into a scale of values indicating the probability of human or robot access. Boundary A shows that the hit is within previously encountered or measured hit times for human access, so the hit has a higher probability of human origin. Boundary B shows that the hit is faster (i.e. smaller) than the minimum human reference and therefore the hit has a higher probability of originating from a robot. As the value of the hit approaches tref_minimum the robot reference minimum the hit has an increasingly higher probability of originating from a robot. When the hit becomes less than tr_ref_minimum (i.e., is faster than the minimum robot reference time, the probability increases that the hit has originated from a robot. The overlap condition where the hit is faster than the average robot hit value tr_ref av indicating that the hit originates from a fast human or from a robot will be resolved by specific embodiments.

Other terms affect the probability that the hit is of non-human origin, more specifically the way that the data item has been accessed. Many information servers such as those to be found on the world wide web provide control files which are used by web search engines and other robot and automated agents but are not accessed from a browser under normal circumstances. Such an example is the robots.txt file that is used to control the way that web search engines such as Yahoo traverse the site. If the robots.txt file has been accessed, there is a very high probability that the hit is non-human in origin. Moreover, the requester ID for the hit can be recognized in future and the probability terms weighted accordingly. Additionally, some embodiments include hyperlinks, file references, data references or other symbols within a world wide web page in a form that is invisible, undetectable and/or inactive when viewed by a Browser, but would be accessed and activated by a robot or another mechanism not using a browser. These additions are termed “Hickstead mines”, or just “mines”. Accesses to mines can be determined in the same manner as described for the robot.txt file and such access would indicate an extremely high probability that the hit originated from a Robot or other non-human mechanism.

If the parent to a new page has not been accessed immediately prior to access of the new page and no other route exists to the new page, there is an increased probability that the access to the new page is from a non-human source and appropriate action could be taken by the server. Robotic emulation of human behavior can be prohibitively time consuming resulting in the robot making direct access to a known hierarchy of files. FIG. 35 illustrates how to generate a time ordered list of all files accessed by a particular Requester ID, allowing the path to the new page to be determined. Additionally, a complete list generated is of all files accessed for a time period t_start, along with the Requester ID's of the accessor of the files. This information is used to determine if a robot or plurality of robots using different Requester ID's is downloading a set of pages in random order.

Some embodiments employ this technique to determine if the entire site, or portions of the site were repeatedly accessed by the same or same set of Requester ID's over a period of time, a practice that is common during competitive analysis of sites as discussed above. Referring to FIG. 35, an index of Requester ID's 3500 includes an index of all the ID's that have “hit” the server Each element in the index corresponds to a Requester ID and points to an index 3504, 3510, 3514 of all the data items accessed by the requester ID. Each element in the indexes 3504, 3510 and 3514 point to the full hit information held in a storage area 3502. Another index 3506 includes all the data items that have been accessed, each element corresponding to an accessed item and pointing to an index 3508, 3512, 3516, 3518 and 3520 of the Requester ID's originating the hit. These elements in turn reference the full hit information held in the storage area 3502.

In this way, a list of data items accessed by a Requester ID can be determined, and also a list of Requester ID's accessing a particular data item can be determined. These indexes are used to determine the path taken to access a data item and also to determine the data items accessed over time. For example, a search made in index 3506 determines what Requester ID's had accessed the file robots.txt and each Requester ID is used to index elements in Index 3500 to determine which other data items the Requester ID had accessed thus identifying those Requester ID's with a high probability of being non-human in origin and also what other files had been accessed.

With knowledge of the page hierarchy (FIG. 31 and FIG. 32) obtained as described in the example above, each page or data item is used in index 3506 to extract a list of Requester ID's and by referencing 3502 the access time is determined. From this information, a frequency distribution map is generated showing what pages or data items had been hit by Requester ID's over a time interval. In this way, it is determined whether particular requester ID's repeatedly accessed the same file or data item set over a period of time providing a higher probability that those Requester ID's are of non-human origin.

Some embodiments provide high speed indexing and retrieval mechanisms for indexes 3500, 3504, 3506, 3508, 3510, 3512, 3514, 3516, 3518 and 3520 and the storage area 3502 allowing substantial real time analysis of the other files the Requester ID had visited within a time period t1 to t2. This is used to determine the route that the Requester ID had taken prior to the data request, to give a probability of the origin of the Requester ID. The process of having to load and re-load parent pages has been shown in FIG. 31 and FIG. 32 and the indexing mechanism shown in FIG. B7 combined with knowledge of the page hierarchy allows a determination of the route taken.

Some embodiments use the probability terms singularly or in combination with the information gained from the indexing system shown in FIG. 35 to produce reports, graphs and other displays indicating the origins of Requester ID's in relation to the data items accessed. Other visual representations may be produced such as graphs, pie-charts, time, data item and Requester ID distribution histograms and others such as are required by the specific embodiments. Other representations are also possible and other indexing may be included into FIG. 35 to cross-reference time stamps and failed or illegal data accesses.

Some embodiments use the probability terms singularly or in combination with the information gained from the indexing system shown in FIG. 35 to automatically take action in the event that the hit origin had a high probability that it as from a non-human origin. Such action may include refusing access. The action may also include the obfuscation of the data item returned to the requester ID or redirection to another area in the server. By determining that certain sections of the server are repeatedly hit by non-human origins, steps may be taken to obfuscate those sections by, for example, replacing all the text within the page with a graphical representation which would still be viewable with a browser but would be almost useless to an information gathering automated agent as described in this invention. Other actions may include pointing to a site which contains useless, confusing, or deliberately incorrect or entangling information (e.g., deeply recursive links), or even monitoring the access to gain useful information about the non-human agent requesting information from the information server.

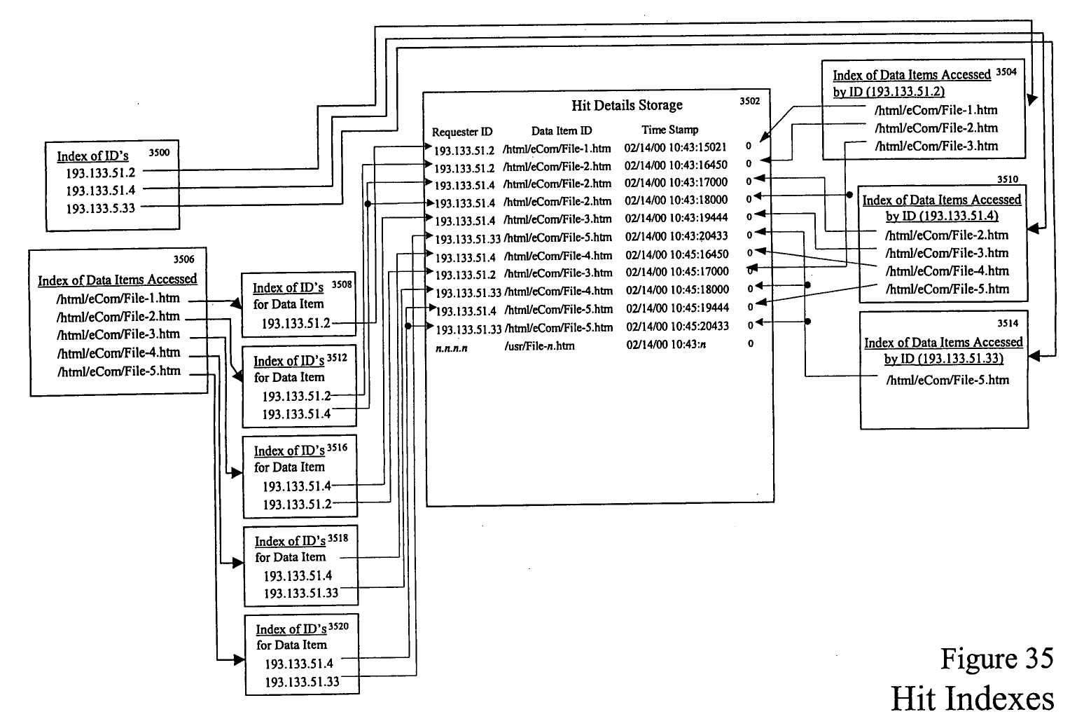

It is now described with reference to FIGS. 36, 37 and 38 how “clerver” technology is used to facilitate the use of adaptive stores. A “clerver” is a combination of client and server technologies. Client systems as commonly used in the art cannot easily share their stored information with other systems. Servers as commonly used in the art are used for mass storage of information that is dispensed to a client in response to an information request by a client.

On the other hand, in accordance with embodiments of the invention, clervers are computational devices (see FIG. 36) that combine the ability to gather, process and share data with clients and other clervers. for example, FIG. 36 shows clervers 3600, 3620, 3650 and 3670 connected to a network onto which is connected other clervers, servers, clients and information repositories (generally, information sources 180). Each of the clervers may operate independently of or in collaboration with any other connected clerver. Some embodiments 3681 use Adaptive stores 3682, 3684; 3686 to hold (in this example) a list of all data extracted 3682, a list of all accesses to data repositories 3684 and a list of all questions 3686 asked of the Clerver by a user, although the number and purpose of such adaptive stores should in no way be considered restricted to that of this example.

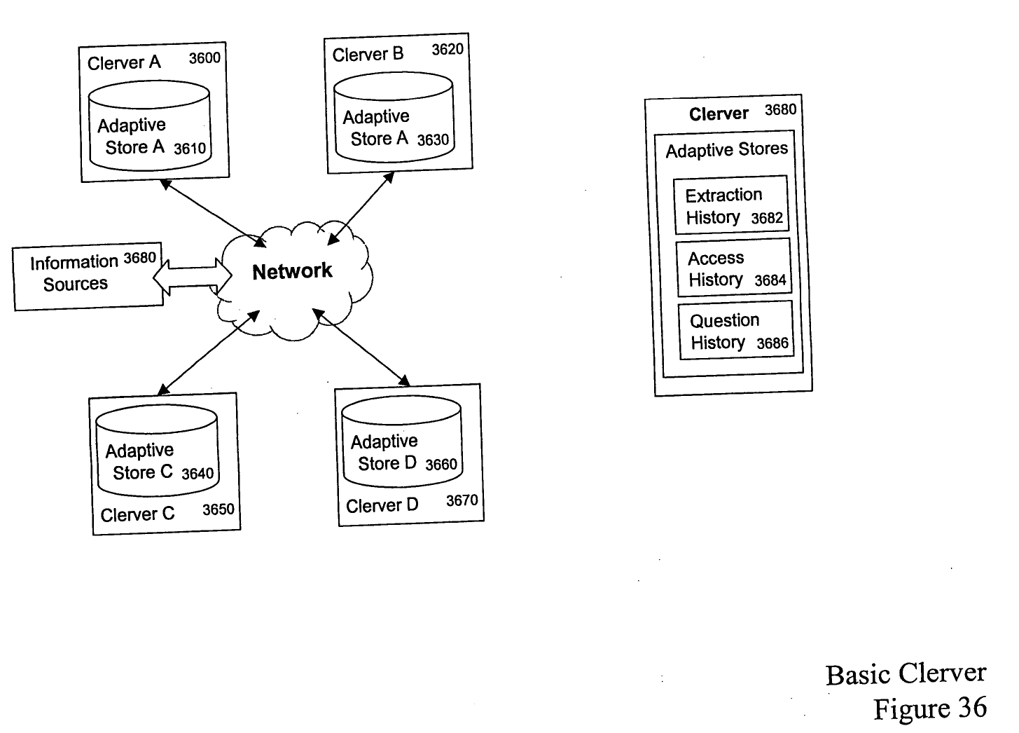

FIG. 37 shows four clervers 3700, 3710, 3726, 3748, 210, 226, 248 interconnected on a network onto which are connected other servers, clervers and data repositories 3630. Particular notice is drawn to the way in which the clervers make available onto the network certain adaptive stores 3706, 3714, 3716, 3720, 3722 such that this data can be accessed by other clervers. Adaptive stores 3702, 2704, 3712, 3724, 3742, 3746 are not made available on the network and can only be accessed directly b the Clerver in which they are held. For example, a 3700 can access its “own” adaptive stores 3702 and 3704 and additionally networked adaptive stores 3714 and 3716 of clerver B 3710 and networked adaptive stores 3720 and 3722 of clerver C 3726, but cannot access the other adaptive stores 3712, 3724, 3740, 3742, 3764 which are not connected to the network. The number of possible interconnections is theoretically unlimited and should in no way be considered limited to the numbers shown in the FIG. 37 example.

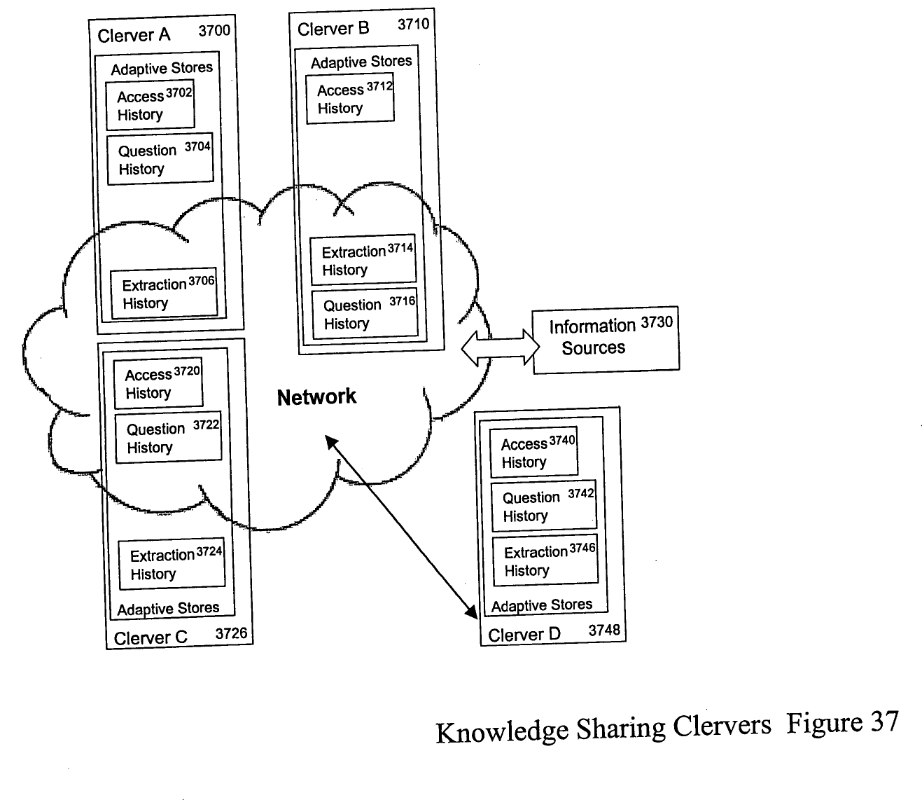

Attention is drawn to another aspect of this interconnection relating to the ability for the adaptive stores to be interconnected in a number of independent networks as illustrated in FIG. 38. Clerver A 3800 includes adaptive stores 3702 and 3804 connected to network 3852 and adaptive store 3806 connected to network 3856. Clerver C 3810 adaptive store 3816 and clerver C 3860 Adaptive Store 3864, 3866 are also connected to network 3856. Network 3850 interconnects adaptive stores 3812, 3814, 3840, 3842 and 3846. The networks 3852, 3856 and 3850 are independent but should not be considered fixed as any adaptive store can theoretically be connected to any other adaptive store that is interconnected on the same network. More particularly, the adaptive store triggers (discussed earlier) can “decide” to connect to another adaptive store dynamically at run-time: there need be no static physical connection.

As for the comparison operation, in some embodiments, the data is “normalized” before comparison. By normalizing the data, the data to be compared is in a contextually compatible format that can then be used to generate reports, compare with other contextually similar data, and other purposes that the specific embodiment may require. However, determining the meaning of the data can require access to potentially large amounts of information. For example, if the data is in the form of a natural language such as English, determining context requires knowledge of the meaning of the words, by access to a potentially large knowledgebase of data. For example, the term “bucks” could refer to a quantity of money used in the United States of America or a plurality of male deer. Clearly, context is required as well as the meaning of the words requiring a knowledge of previously encountered or used words, terms, phrases, sentences, etc. Some estimates put the number of words in common usage at over 300,000, other estimates put the number of acronyms in common usage at over 190,000, specific types of industry use extensive terminology, examples being Latin names in biology and medical names for drugs.

The context of the data influences the size of the knowledge base contained within the adaptive stores. An aspect of this invention provides a storage system that intelligently adapts to the nature and context of the data being stored and accessed, greatly reducing the amount of storage space required. Such intelligent adaptation to data usage is particularly useful for situations where storage space is limited, such as WWW browsers and wireless devices. Another aspect of the invention links this aforementioned adaptive storage with contextual knowledge that a particular sequence of data will follow. For example, embodiments processing information about Lions will find the statement “Lions eat Zebra” more likely than “lions eat mountains” since Zebra is a food and mountains are very large rocks. The word “eat” implies that the next term or word will be a food product in the context of a mammalian carnivore. Embodiments thus pre-load adaptive stores with words of a carnivorous food context eliminating the need to examine a larger knowledge base.

Consumers and businesses can all benefit from a mechanism that facilitates the easy identification and comparison of data. For example, those performing electronic commerce can easily identify and catalog information on web repositories of their competitors.

The ability of a data server to process the data requests is often dependent on the nature of the specific request which can result in the servers inability to service other requests. Data requests may have different priorities; for example, an eCommerce server may place higher priority to performing the activities associated with a credit card transaction than to servicing a request for an image on a web site that could take lower priority. In this example, lower priority requests could be delayed until such time as the higher priority activities are complete. The prioritization of data requests and their processing requirements are performed by specific embodiments in accordance with this invention or in the form of an external data input. Examples of such inputs are from another data server or another component of the same server etc. For example, a data server could specify that all data requests to images files should be delayed by a factor dependent on the total load on the server.

Having described certain embodiments of the invention, it will now become apparent to those of skill in the art that other embodiments incorporating the concepts of the invention may be used. Therefore, the invention should not be limited to certain embodiments, but rather should be limited only by the spirit and scope of the disclosure.

1. In a computer network having a plurality of interconnected computer resources, the computer network having associated with it a data repository that includes a plurality of data items in electronic format distributed widely among the interconnected computer resources, a method of locating portions of the electronic data in the data repository based on a search query, comprising:
processing the search query to determine at least one meaning associated with the search query; and
locating the portions of the electronic data based on the determined meaning and in accordance with a context ascribed to the determined meaning with reference to meanings associated with previous result data, located in response to previous search queries.

2. The method of claim 1, wherein:
the previous result data is organized in a particular manner to ascribe the context to the determined meaning; and
the locating step includes, based on the particular manner of organization, comparing the determined meaning to the meanings associated with previous result data.

3. The method of claim 2, wherein:
the comparing step includes:
comparing the determined meaning to the meanings associated with the previous result data in a particular order that is based on the particular manner of organization.

4. The method of claim 2, and further comprising:
maintaining a store of the meanings associated with the previous result data, organized in the particular manner.

5. The method of claim 4, wherein the particular manner is order of locating the previous result data.

6. The method of claim 3, wherein the order of comparing is based at least in part on a relative frequency with which the previous result data has been accessed.

7. The method of claim 1, wherein:
the search query is by a particular user; and
the previous search queries include search queries by users other than the particular user.

8. The method of claim 7, wherein:
the previous result data is organized in the plurality of results stores in a particular manner that ascribes the context of the determined meaning; and
the locating step includes, based on the particular manner of organization, comparing the determined meaning to the meanings associated with the previous result data.

9. The method of claim 1, wherein:
the method further includes maintaining a pointer store that includes at least one entry pointing to a store of previous result data; and
the locating step includes initially locating the store of previous result data based on the pointer store.

10. The method of claim 2, and further comprising:
maintaining the particular manner of organization.

11. The method of claim 10, wherein:
the maintaining step includes, when a particular previous result data is located based on the search query, organizing the previous result data to influence the prominence with which the located particular previous result data affects the ascription of context.

12. The method of claim 11, wherein:
the previous result data are co-accessible by a plurality of users presenting search queries; and
in the maintaining step, the organizing step is executed based on the particular previous result data located based on the search queries presented by the plurality of users.

13. The method of claim 7, wherein:
the previous result data are co-accessible by the particular user and the other users.

14. A method of emulating access to a data repository by a particular type of access mechanism, comprising:
analyzing a collection of representative accesses by the access mechanism to determine a collective access signature; and
accessing the data repository by performing actions in accordance with the determined access signature.

15. A method of detecting whether a collection of actions to access a data repository is not by a particular type of access mechanism, comprising:
analyzing the collection of actions to determine a collective access signature; and
processing the collective access signature to determine a probability that the collection of accesses is not by the particular type of access mechanism.

16. The method of claim 15, wherein:
the processing step includes a step of determining a probability based initially on an indication within the collective access signature of a frequency value that corresponds to the frequency with which the accesses are occurring.

17. The method of claim 16, wherein:
in the processing step, when the frequency value indicated within the collective access signature is above a particular threshold, further processing the collective access signature to determine a probability that the collection of accesses is not by the particular type of access mechanism based on other properties of the collection of accesses, other than frequency, indicated in the signature.

18. The method of claim 16, wherein:
in the processing step, the probability determining step includes determining whether the frequency value is above a particular frequency value threshold.

19. The method of claim 18, wherein:
the method further comprises determining the particular frequency value threshold based on frequency of prior accesses to the data repository.

20. The method of claim 17, wherein:
the other properties includes an order in which the accesses of the collection of accesses occur.

21. The method of claim 20, wherein the method includes:
determining the order in which the accesses of the collection of accesses occurs from an order value indicated in the access signature; and
comparing the actual order against the determined order.

22. The method of claim 17, wherein:
the other properties includes at least one of time between accesses and order of accesses.

23. The method of claim 17, wherein:
the other properties includes an access to a data item that would normally only be accessed by an automated mechanism.

24. The method of claim 23, wherein:
the method further comprises introducing into the data repository the components that would normally only be accessed by an automated mechanism.

25. The method of claim 15, and further comprising:
when the collection of actions to access the data repository is determined to be not by a particular type of access mechanism, taking at least one of the actions of:
for at least one access after the collection of accesses, modifying the data that would otherwise be provided out of the data repository;
for at least one access after the collection of accesses, not responding to the access to the data repository;
for at least one access after the collection of accesses, providing data in addition to the data that would otherwise be provided out of the data repository; and
for at least one access after the collection of accesses, delaying a response to the access.
